(19) United States
(12) Patent Application Publication
(10) Pub. No.: US 2026/0284960 A1
(43) Pub. Date: Sep. 24, 2026

(54) POROUS INK WITH CONTROLLABLE INTERCONNECTION WIDTH AND 3D PRINTING METHOD USING THE SAME

(71) Applicant: GACHON UNIVERSITY OF INDUSTRY-ACADEMIC COOPERATION FOUNDATION, Seongnam-si (KR)

(72) Inventor: Jongkyeong LIM, Seoul (KR)

(21) Appl. No.: 19/295,725

(22) Filed: Aug. 11, 2025

(30) Foreign Application Priority Data
Mar. 19, 2025 (KR) 10-2025-0035315
May 19, 2025 (KR) 10-2025-0064428

(51) Int. Cl. B29C 64/106; B29C 64/30; B29K 105/00; B29K 105/04

(52) U.S. Cl. CPC B29C 64/106; B29C 64/30; B29K 2105/0094; B29K 2105/041; B29K 2105/251; B29K 2995/0077

(57) ABSTRACT

Provided is an interconnection-tunable porous ink including: a continuous medium containing a polymer or polymer precursor; solid particles dispersed in the continuous medium; and a surface wetting liquid flowing on the solid particle surface, in which the surface wetting liquid forms capillary bridges between the solid particles to exhibit viscoelastic properties.

### CROSS-REFERENCE TO RELATED APPLICATION

This application claims the priority of Korean Patent Application No. 10-2025-0035315 filed on Mar. 19, 2025, and Korean Patent Application No. 10-2025-0064428 filed on May 19, 2025, in the Korean Intellectual Property Office, the disclosure of which is incorporated herein by reference.

### BACKGROUND

### Field

The present disclosure relates to fabrication of a porous structure, and more particularly, to a porous ink composition capable of precisely controlling an interconnection width and a 3D printing method using the same.

### Description of the Related Art

A three-dimensional (3D) porous structure has the characteristic of being able to form a complex appearance while including a continuous pore network therein. Such a structure provides functionality necessarily required for a variety of engineering and life science applications, including soft robotics, microfluidic systems, precision filtration and purification devices, biomaterials, and the like.

The performance of the porous structure is not simply determined only by the overall porosity or the average pore size, and an interconnection width acts as a main control variable. In particular, the size and shape of the connections are closely related to not only mechanical properties, such as compressive strength and tensile strength of the structure, but also various functionalities, such as diffusion rate of materials, fluid transfer efficiency, flow resistance and selective filtration properties.

As conventional porous structure fabrication techniques, processes using physical or chemical behavior, such as gas foaming, freeze drying, phase separation, and direct foaming have been mainly used. These methods have been widely used in that it is easy to adjust pore sizes and process experience has been accumulated, but are sensitive to external conditions (temperature, pressure, cooling rate, etc.), have low reproducibility, are difficult to be applied to various material series, and have limitations in that energy consumption is large and process time is long.

In particular, existing technologies have limitations in precisely controlling the interconnection width, and are limited to the implementation of complex 3D shapes, which are not sufficient for modern applications requiring complex functions. As an alternative to overcome these limitations, template-based removal-type production methods using crystalline particles such as sugar, salt, and ice have been proposed, and among them, a sugar template has been most widely used due to easy removability and eco-friendly process conditions. However, the sugar template also has limitations in interconnection control, an autonomous structure design is difficult, and there are limitations in implementing complex shapes, so that availability is limited.

Recent 3D printing techniques, particularly direct ink writing (DIW), have an advantage of being able to fabricate a precise 3D structure using various materials, and may maximize a printing freedom degree through a functional ink composition design. However, materials such as PDMS, which are high-elastic polymers, are difficult in DIW printing due to low yield stress and non-thixotropic viscoelasticity, and a separate precursor modifier or additive design is required to overcome the problem.

Therefore, in order to implement a customized porous structure suitable for application purposes, there is a need for a new fabrication technology capable of precisely designing and adjusting not only porosity and pore size but also an interconnection structure. Beyond simple physical properties, the technology is on the basis of integrally achieving the complex performance required for a highly functional system.

As the background of the present disclosure, Korean Patent Publication No. 10-2023-0048820 relates to an ink composition for forming a porous member, a method for fabricating a porous member using the same, and a porous member fabricated through the same.

### SUMMARY

In order to solve the problems of the related art described above, an object of the present disclosure is to provide an interconnection-tunable porous ink composition capable of precisely controlling an interconnection width.

Another object of the present disclosure is to provide a 3D printing method using the interconnection-tunable porous ink.

Yet another object of the present disclosure is to provide a porous structure fabricated by the 3D printing method.

Still another object of the present disclosure is to provide an oil-water separation system and a pressure sensor including the porous structure.

However, objects of the present disclosure to be achieved are not limited to the above-mentioned objects, and other objects may be present.

As a technical means for achieving the technical object, a first aspect of the present disclosure provides an interconnection-tunable porous ink including: a continuous medium containing a polymer or a polymer precursor; solid particles dispersed in the continuous medium; and a surface wetting liquid flowing on the surface of the solid particles, in which the surface wetting liquid forms capillary bridges between the solid particles to exhibit viscoelastic properties.

According to one embodiment of the present disclosure, the surface wetting liquid may have a contact angle of less than 90° on the solid particle surface, but is not limited thereto.

According to one embodiment of the present disclosure, the surface wetting liquid may be immiscible with the continuous medium, but is not limited thereto.

According to one embodiment of the present disclosure, the solid particles may not be dissolved in the continuous medium and the surface wetting liquid, but are not limited thereto.

According to one embodiment of the present disclosure, the solid particles may be dissolved through a solvent or sublimated by heat, but are not limited thereto.

According to one embodiment of the present disclosure, the surface wetting liquid may be removed through a solvent or vaporized by heat, but is not limited thereto.

According to one embodiment of the present disclosure, a yield stress of the interconnection-tunable porous ink may be increased by the capillary bridges, but is not limited thereto.

According to one embodiment of the present disclosure, the polymer or polymer precursor may be selected from the group consisting of polydimethylsiloxane (PDMS), silicone-based room temperature vulcanizing resins (RTV), Ecoflex, polyurethane, epoxy resin, acrylate-based resin, polyvinyl alcohol (PVA), polyethylene glycol (PEG), Pluronic F127, alginate, gelatin, collagen, agarose, hyaluronic acid, chitosan, carrageenan, polyacrylamide, polyethylene glycol diacrylate (PEGDA), 2-hydroxyethyl methacrylate (HEMA), N-isopropylacrylamide (NIPAM), polycaprolactone (PCL), polyacrylic acid (PAA), and combinations thereof, but is not limited thereto.

According to one embodiment of the present disclosure, the polymer or polymer precursor may further include functional particles selected from the group consisting of graphite, silicon-based composites, silver (Ag) nanoparticles, gold (Au) nanoparticles, copper (Cu) nanoparticles, nickel (Ni) nanoparticles, cobalt (Co) nanoparticles, platinum (Pt) nanoparticles, palladium (Pd) nanoparticles, silicon dioxide (SiO₂), titanium dioxide (TiO₂), aluminum oxide (Al₂O₃), zinc oxide (ZnO), zinc peroxide (ZnO₂), hexagonal boron nitride (BN), carbon black, carbon nanotubes (CNTs), graphene, magnetite (Fe₃O₄), MXene, conductive polymers (PEDOT:PSS), and combinations thereof, but is not limited thereto.

According to one embodiment of the present disclosure, the solid particles may be selected from the group consisting of sugar particles, sodium chloride (NaCl) particles, potassium chloride (KCl) particles, polystyrene, polymethylmethacrylate (PMMA), polyvinylalcohol (PVA), camphor, urea, citric acid, naphthalene cellulose nanocrystals, cellulose nanofibers, starch particles, chitin/chitosan microparticles, calcium carbonate, hydroxyapatite, silk fibroin microparticles, polylactic acid (PLA) particles, polycaprolactone microparticles, and combinations thereof, but are not limited thereto.

According to one embodiment of the present disclosure, the surface wetting liquid may be selected from the group consisting of glycerol, ethylene glycol, propylene glycol, water, surfactants, dimethyl carbonate (DMC), isopropyl alcohol (IPA), ethanol, acetone, dimethyl sulfoxide (DMSO), toluene, silicone oil, mineral oil, chloroform, hexane, heptane, fluorinated oils, and combinations thereof, but is not limited thereto.

According to one embodiment of the present disclosure, the surface wetting liquid may further include functional particles selected from the group consisting of graphite, silicon-based composites, silver (Ag) nanoparticles, gold (Au) nanoparticles, copper (Cu) nanoparticles, nickel (Ni) nanoparticles, cobalt (Co) nanoparticles, platinum (Pt) nanoparticles, palladium (Pd) nanoparticles, silicon dioxide (SiO₂), titanium dioxide (TiO₂), aluminum oxide (Al₂O₃), zinc oxide (ZnO), zinc peroxide (ZnO₂), hexagonal boron nitride (BN), carbon black, carbon nanotubes (CNTs), graphene, magnetite (Fe₃O₄), MXene, conductive polymers (PEDOT:PSS), and combinations thereof, but is not limited thereto.

According to one embodiment of the present disclosure, the solid particles may be included in an amount of 30 vol % to 90 vol % with respect to the total composition of the interconnection-tunable porous ink, but are not limited thereto.

According to one embodiment of the present disclosure, a volume ratio (R) of the surface wetting liquid to the volume of the solid particles represented by the following Equation 1 may be 0.1 vol % to 70 vol %, but is not limited thereto:

$$R ( vol \% ) = \frac{Volume of surface wetting liquid}{\begin{matrix}Volume of solid particles + \\ Volume of surface wetting liquid\end{matrix}} \times 100 \qquad [ Equation 1 ]$$

According to one embodiment of the present disclosure, the solid particles may have a diameter of 0.1 μm to 1000 μm, but are not limited thereto.

According to one embodiment of the present disclosure, the interconnection-tunable porous ink may have a yield stress of 200 Pa or more, but is not limited thereto.

According to one embodiment of the present disclosure, the interconnection-tunable porous ink may exhibit a liquid-like behavior under a shear stress higher than the yield stress of the interconnection-tunable porous ink, and exhibit a solid-like behavior under a shear stress lower than the yield stress of the interconnection-tunable porous ink, but is not limited thereto.

Further, a second aspect of the present disclosure provides a 3D printing method using the interconnection-tunable porous ink according to the first aspect of the present disclosure, the 3D printing method including: ejecting the interconnection-tunable porous ink through a 3D printer to form a structure having a predetermined shape; curing the structure; and removing the solid particles and the surface wetting liquid, in which pores are formed in the structure by removing the solid particles, and interconnections are formed in the structure by removing capillary bridges formed of the surface wetting liquid.

According to one embodiment of the present disclosure, the curing may be performed by a thermal curing, photocuring or auto-curing process, but is not limited thereto.

According to one embodiment of the present disclosure, the removing of the solid particles and the surface wetting liquid may be performed by solvent washing or sublimation/vaporization, but is not limited thereto.

According to one embodiment of the present disclosure, a diameter of the interconnection may be controlled by adjusting the concentration of the surface wetting liquid included in the interconnection-tunable porous ink, but is not limited thereto.

According to one embodiment of the present disclosure, the interconnection may have a diameter of 0.01 μm to 100 μm, but is not limited thereto.

According to one embodiment of the present disclosure, the size of the pores may be controlled by adjusting the size of the solid particles included in the interconnection-tunable porous ink, but is not limited thereto.

According to one embodiment of the present disclosure, the pores may have a diameter of 0.1 μm to 1000 μm, but are not limited thereto.

Further, a third aspect of the present disclosure provides a porous structure fabricated by the 3D printing method according to the second aspect of the present disclosure.

Further, a fourth aspect of the present disclosure provides an oil-water separation system, including the porous structure according to the third aspect of the present disclosure.

Further, a fifth aspect of the present disclosure provides a pressure sensor, including the porous structure according to the third aspect of the present disclosure.

Further, a sixth aspect of the present disclosure provides a battery electrode including the porous structure according to the third aspect of the present disclosure.

The above-mentioned technical solutions are merely exemplary and should not be construed as limiting the present disclosure. In addition to the above-described embodiments, additional embodiments may exist in the drawings and detailed description of the present disclosure.

According to the present disclosure, the interconnection-tunable porous ink is a new type of porous material capable of precisely controlling the interconnection width, and can overcome the shape freedom and structural control limitations of conventional porous structure fabrication methods. Particularly, the shape of the interconnection can be precisely controlled in the range of 0.1 μm to 100 μm by adjusting the content of the surface wetting liquid and the properties (size, amount, surface energy, etc.) of the solid particles, thereby enabling the design of customized porous structures suitable for applications.

In addition, the interconnection-tunable porous ink is converted into a viscoelastic paste having a thixotropic property due to an increased yield stress by formation of capillary bridges. Such a property maintains the structure under a low shear stress and exhibits a viscoelastic flow at a high stress, thereby imparting rheological properties suitable for 3D printing. Specifically, precise printing is enabled by direct ink writing (DIW) even while having a yield stress of 200 Pa or more, thereby fabricating porous structures having various 3D shapes.

Furthermore, the 3D printing method uses a mechanism in which pores and interconnections are formed by removing capillary bridges formed by solid particles and a surface wetting liquid. The 3D printing method provides an advantage of being able to precisely adjust the presence or absence of the connection and the connection widths within the same porosity even without changing separate process conditions. Such a process can be applied to various polymer systems such as PDMS, Ecoflex, and urethane, and thus has a high degree of freedom in material selection.

In addition, the porous structure has excellent mechanical properties. The porous structure can be compressed without structural damage even under a high strain of up to 90%, and is quickly restored to its original shape after load removal, and exhibits a stress retention rate of about 98% because the loss of maximum stress is only about 2% even after 1000 or more repeated compressions. This means that the porous structure has excellent energy dissipation performance and fast recovery capability together with superelastic properties.

In addition, the porous structure according to the present disclosure can also be used in various applications, including oil-water separation systems, microfluidic systems, pressure sensing sensors, and the like. In particular, in the oil-water separation system, an oil absorption capacity of up to 170% can be achieved by adjusting the interconnection width, and in the microfluidic system, a speed at which a liquid is passively discharged can be controlled without external pumps or valves. In addition, the porous structure filled with a liquid metal can function as a flexible and stretchable pressure sensor, which can be practically used in various fields requiring high-precision functional materials, such as soft robotics, biomedical sensors, energy storage systems, and the like.

However, effects obtainable herein are not limited to the effects described above, and other effects may be present.

### BRIEF DESCRIPTION OF THE DRAWING

The above and other aspects, features and other advantages of the present disclosure will be more clearly understood from the following detailed description taken in conjunction with the accompanying drawings, in which:

FIG. 1A is a schematic diagram of a process for fabricating a 3D porous structure using ITPI, FIG. 1B shows an ITPI-based porous structure including interconnections formed based on capillary bridges, and FIG. 1C shows that an interconnection structure is not formed with a structure fabricated from an ink excluding a surface-wetting liquid phase;

FIG. 2A shows viscoelastic properties of p-ITPI according to the presence of glycerol (5 vol %), FIG. 2B shows changes in tan (delta) of p-ITPI according to a glycerol content (0 to 25 vol %), FIG. 2C shows changes in complex viscosity, FIGS. 2D and 2E show changes in yield stress and storage modulus (G′), and FIG. 2F shows thixotropic properties for p-ITPI of a glycerol 10 vol % composition;

FIG. 3A shows a process for fabricating a 3D porous structure using p-ITPI by a direct ink writing method, FIG. 3B shows 3D porous PDMS structures having various shapes made by p-ITPI, and FIG. 3C is a cross-sectional image of a printed porous filament. FIG. 3D shows a SEM image of a porous structure according to a glycerol concentration, FIG. 3E shows a result of measuring pore network sizes in the porous structure according to a glycerol concentration, FIG. 3F shows a result of measuring the most distributed width of interconnections, and FIG. 3G shows changes in pore size;

FIG. 4A shows porous structure-formable regions according to sugar and glycerol contents based on 30 μm sugar particles, FIG. 4B shows a mechanism in which a large amount of PDMS residue remains after removing the sugar and glycerol at a high sugar concentration of 70% or more, and structure formation fails, and FIG. 4C shows a porous structure formed at a sugar content of 50 vol % or less, indicating that low porosity and weak connectivity are observed;

FIG. 5 is a diagram illustrating a DIW 3D printer system;

FIG. 6A shows a SEM image of a porous PDMS structure fabricated with 50 vol % sugar particles at various glycerol concentrations, FIG. 6B shows a result of measuring pore network sizes according to a glycerol concentration, FIG. 6C shows a result of measuring the most distributed width of interconnections according to a glycerol concentration and FIG. 6D shows changes in pore size according to a glycerol concentration;

FIG. 7A shows a SEM image of a structure fabricated using sugar particles having various sizes (to 30 μm, 100 to 300 μm, 300 to 500 μm, and 500 μm or more), FIG. 7B shows a result of measuring porosity according to a sugar particle size, FIG. 7C shows a width distribution of distributing the most interconnections according to a sugar particle size, and FIG. 7D shows average pore sizes according to a used sugar particle size;

FIG. 8 is a diagram showing a possibility of fabricating porous structures using various continuous medium materials;

FIG. 9A shows a compression test process, and FIG. 9B shows a stress-strain (6-8) curve of a structure fabricated with p-IPTI according to different glycerol concentrations. FIG. 9C shows a strain of a structure made by p-ITPI containing 10 vol % glycerol, FIG. 9D shows a compressive rate, FIG. 9E shows a stress-strain curve according to repeated compression, and FIG. 9F shows a result of hysteresis loop analysis after repeated cycles;

FIG. 10A shows a PDMS sponge with hydrophobic and lipophilic properties, FIG. 10B shows a water-oil separation process using a PDMS sponge, FIG. 10C shows porosity of a PDMS sponge made by p-ITPI according to different glycerol concentrations, FIG. 10D shows an oil absorption capacity, and FIG. 10E shows normalized porosity and oil absorption capacity;

FIG. 11A shows fabrication of a porous sponge and a result of infusing an aqueous dye, and FIG. 11B shows a straight PDMS microchannel system configuration with inlet and outlet wells. FIG. 11C shows a time-lapse image in which a dye contained in a sponge made by p-ITPI with a glycerol 5 vol % composition is diffused along a channel for 90 minutes, FIG. 11D shows a time-lapse image in which a directly infused dye is diffused along the channel, FIG. 11E shows a dye diffusion curve according to an interconnection width of a sponge, and FIG. 11F shows a change in a dye arrival time that decreases as the interconnection width increases in the sponge; and

FIG. 12A is a schematic diagram of a process for vacuum-based filling with LM in a porous structure, FIG. 12B shows a minimum interconnection width for LM filling based on a Laplace pressure theory, and FIG. 12C shows a process of fabricating an LM sponge electrode by step.

FIG. 12D shows a relative resistance change rate (ΔR/R₀) at a maximum of 50% tensile, FIG. 12E shows a resistance change rate at various curvature conditions, and FIG. 12F shows a resistance change rate at a maximum of 1000 kPa pressure. FIG. 12G shows a coil embolization simulation using a hand attached with an LM sponge electrode sensor, and FIG. 12H shows results of measuring real-time resistance changes according to an increase in packing density during coil insertion.

### DETAILED DESCRIPTION

Hereinafter, examples of the present disclosure will be described in detail so as to be easily implemented by those skilled in the art, with reference to the accompanying drawings. However, the present disclosure may be embodied in many different forms and are not limited to the examples to be described herein. In addition, parts not related with the description have been omitted in order to clearly describe the present disclosure in the drawings and throughout the present specification, like reference numerals designate like elements.

Further, throughout this specification, when a certain part is “connected” with the other part, it is meant that the certain part may be “directly connected” with the other part and “electrically connected” with the other part with another element interposed therebetween.

Throughout the present specification, it will be understood that when a certain member is located “on”, “above”, “at the top of”, “under”, “below”, and “at the bottom of” the other member, a certain member is in contact with the other member and another member may also be present between the two members.

Throughout the specification, a case where a part “includes” an element will be understood to imply the inclusion of stated elements but not the exclusion of any other elements unless explicitly described to the contrary.

The terms “about”, “substantially”, and the like to be used in the specification are used as a numerical value or a value close to the numerical value when inherent manufacturing and material tolerances are presented in the stated meaning, and used to prevent an unscrupulous infringer from unfairly using disclosed contents in which precise or absolute numerical values are mentioned to help in the understanding of the present disclosure. Throughout the present specification, the term of “step to” or “step of” does not mean “step for”.

Throughout the present specification, the term “combinations thereof” included in the expression of the Markush form means one or more mixtures or combinations selected from the group consisting of components described in the expression of the Markush form, and means to include at least one selected from the group consisting of the components.

Throughout the present specification, “A and/or B” means “A or B, or A and B”.

Hereinafter, a biosensor and a method for fabricating the same of the present disclosure will be described in detail with reference to embodiments, Examples, and drawings. However, the present disclosure is not limited to these embodiments, Examples, and drawings.

As a technical means for achieving the technical object, a first aspect of the present disclosure provides an interconnection-tunable porous ink including: a continuous medium containing a polymer or a polymer precursor; solid particles dispersed in the continuous medium; and a surface wetting liquid flowing on a surface of the solid particles, in which the surface wetting liquid forms a capillary bridge between the solid particles to exhibit viscoelastic properties.

The interconnection-tunable porous ink (hereinafter referred to as “ITPI”) proposed in the present disclosure is a new type of composition capable of precisely controlling an interconnection width. The ITPI is based on a multiphase suspension structure and consists of a continuous medium (CM), a solid suspension phase (SSP), and a surface-wetting liquid phase (SLP). Each of these three components plays a key role in porous structure formation and rheological properties, such as a porosity, a pore size, and an interconnection width.

The continuous medium consists mainly of a polymer or polymer precursor and is responsible for forming the final skeleton of the structure. The solid suspension phase is dispersed in the continuous medium in the form of insoluble particles and is responsible for the formation of main pores in the ink and adjustment of sizes thereof. The surface-wetting liquid phase is a liquid having excellent wettability while being immiscible with the continuous medium and insoluble with the solid particles, and may form capillary bridges between the particles under a condition in which a contact angle with the surface of the solid particles is less than 90°.

These capillary bridges induce local agglomeration between the solid particles, and as result, a narrow passage, i.e. an interconnection, localized in an interparticle gap is naturally formed. In addition, the capillary bridges increase the yield stress of the ink, maintain the structure under low shear stress, and exhibit a viscoelastic flow at high stress, thereby imparting rheological properties suitable for direct ink writing.

According to one embodiment of the present disclosure, the surface wetting liquid may have a contact angle of less than 90° on the solid particle surface, but is not limited thereto.

The surface wetting liquid is advantageous for formation of capillary bridges when having a contact angle of less than 90° with respect to the solid particle surface. When the contact angle is less than 90°, the liquid exhibits wettability with respect to the solid surface, and the property is required for the liquid to spread along the solid particle surface and form capillary bridges in interparticle gaps. The capillary bridges generate cohesive force between the particles due to a surface tensile that occurs at a liquid-gas interface. The capillary bridges allow the particles to be drawn together to form a concentrated multiphase structure.

According to one embodiment of the present disclosure, the surface wetting liquid may be immiscible with the continuous medium, but is not limited thereto.

The surface wetting liquid needs to be immiscible with the continuous medium. This is for the surface wetting liquid to remain separated in the continuous medium and to selectively adhere to the solid particle surface to form capillary bridges. If the surface wetting liquid is mixed with the continuous medium, the capillary bridges are not formed and the surface wetting liquid is evenly dispersed throughout the ink, so that local agglomeration required for the formation of an interconnected structure does not occur.

According to one embodiment of the present disclosure, the solid particles may not be dissolved in the continuous medium and the surface wetting liquid, but are not limited thereto.

The solid particles should not be dissolved in the continuous medium and the surface wetting liquid. This is to act as a template for pore formation while the solid particles are maintained in a physical form within the ITPI. When the solid particles are dissolved in the continuous medium or the surface wetting liquid, the size of the particles decreases, or the shape is deformed to affect the size and shape of the pores formed in the final structure. In particular, when dissolved in the continuous medium, the framework structure itself may become unstable, and when dissolved in the surface wetting liquid, a solid surface necessary for capillary bridge formation is not provided. Accordingly, the physical stability of the solid particles acts as an important factor in the structure formation and functional properties of the ITPI.

According to one embodiment of the present disclosure, the solid particles may be dissolved through a solvent or sublimated by heat, but are not limited thereto.

The solid particles need to have removable properties during the final porous structure fabrication process. Only the solid particles may be selectively removed in the cured continuous medium by using a material (e.g., sugar particles dissolved in water) that is soluble through a solvent or a material (e.g., caffeine, naphthalene, etc.) that may be sublimated by heat. The selective removal process allows precise pore formation inside the structure, and the size and distribution of the pores directly correspond to the size and distribution of the solid particles used. In particular, a dissolution method using a solvent is widely used by effectively removing the solid particles without damage to the structure. In addition, the sublimation method using heat may be effectively used in an environment in which the use of a solvent is limited or in an application field in which the problem of a residual solvent needs to be avoided.

According to one embodiment of the present disclosure, the surface wetting liquid may be removed through a solvent or vaporized by heat, but is not limited thereto.

The surface wetting liquid needs also to have removable properties in a final porous structure fabrication process. The surface wetting liquid forms capillary bridges on the surface of the solid particles and plays a key role in the formation of interconnections, and then the interconnections are formed in the removed sites in the process of removal through the solvent or vaporization by heat. For example, the surface wetting liquid such as glycerol may be dissolved in water and then easily removed during a washing process, and vaporizable liquids (e.g., alcohol series) even at a relatively low temperature may be effectively removed through heat treatment. The removal method of the surface wetting liquid may be selected considering the properties of a continuous medium, target applications, process conditions, etc., which may affect the microstructure and functional properties of the final porous structure.

According to one embodiment of the present disclosure, the yield stress of the interconnection-tunable porous ink may be increased by the capillary bridges, but is not limited thereto.

The capillary bridges increase the yield stress of the ITPI. The capillary bridges formed between the solid particles generate cohesive force between the particles due to surface tension at a liquid-gas interface. The cohesive force increases the yield stress by increasing the ability of the ITPI to resist external force. The increased yield stress imparts a thixotropic property where the ITPI maintains the structure under a low shear stress and exhibits a flow at high shear stress. This thixotropic property plays an important role in simultaneously ensuring the possibility of extrusion through nozzles during the 3D printing process and the ability to maintain the shape after extrusion.

According to one embodiment of the present disclosure, the polymer or polymer precursor may be selected from the group consisting of polydimethylsiloxane (PDMS), silicone-based room temperature vulcanizing resins (RTV), Ecoflex, polyurethane, epoxy resin, acrylate-based resin, polyvinyl alcohol (PVA), polyethylene glycol (PEG), Pluronic F127, alginate, gelatin, collagen, agarose, hyaluronic acid, chitosan, carrageenan, polyacrylamide, polyethylene glycol diacrylate (PEGDA), 2-hydroxyethyl methacrylate (HEMA), N-isopropylacrylamide (NIPAM), polycaprolactone (PCL), polyacrylic acid (PAA), and combinations thereof, but is not limited thereto.

The polymer or polymer precursor used as the continuous medium may include various kinds of materials and may be selected depending on a target application and required physical, chemical, and biological properties. The polymers or polymer precursors may be broadly classified into synthetic polymers and natural polymers.

Among synthetic polymers, the PDMS is widely used with properties such as high stretchability, chemical stability, biocompatibility, and transparency, and the silicone-based RTV has the characteristic of being crosslinked at room temperature. The Ecoflex provides the characteristics of superelasticity and low hardness, and the polyurethane has excellent mechanical strength and abrasion resistance. The epoxy resin and the acrylate-based resin provide high strength and excellent chemical resistance. The PVA, PEG, and Pluronic F127 are water-soluble polymers and suitable for fabrication of hydrophilic structures, and the PEGDA, HEMA, and NIPAM are advantageous for microstructure control due to their photocurable properties.

Among natural polymers, alginate, gelatin, collagen, agarose, hyaluronic acid, chitosan, carrageenan, and the like are excellent in biocompatibility and suitable for cell culture and tissue engineering applications. These natural polymers are often biodegradable and may be effectively used in temporary structures or drug delivery systems.

In particular, the physical properties of the polymer or polymer precursor directly affect the mechanical properties (e.g., strength, elasticity, resilience), surface properties (e.g., hydrophilicity/hydrophobicity, biocompatibility), and functional properties (e.g., swelling behavior, thermal/electrical conductivity) of the final porous structure, so that it is important to select an optimal polymer or polymer precursor according to a target application. In addition, two or more polymers or polymer precursors may be combined to fabricate a porous structure having complex properties.

According to one embodiment of the present disclosure, the polymer or polymer precursor may further include functional particles selected from the group consisting of graphite, silicon-based composites, silver (Ag) nanoparticles, gold (Au) nanoparticles, copper (Cu) nanoparticles, nickel (Ni) nanoparticles, cobalt (Co) nanoparticles, platinum (Pt) nanoparticles, palladium (Pd) nanoparticles, silicon dioxide (SiO₂), titanium dioxide (TiO₂), aluminum oxide (Al₂O₃), zinc oxide (ZnO), zinc peroxide (ZnO₂), hexagonal boron nitride (BN), carbon black, carbon nanotubes (CNTs), graphene, magnetite (Fe₃O₄), MXene, conductive polymers (PEDOT:PSS), and combinations thereof, but is not limited thereto.

The polymer or polymer precursor may be added with various functional particles to enhance the physical, chemical, electrical, optical, magnetic properties of a base medium or impart new functions. These functional particles play an important role in expanding the application range of the porous structure and optimizing the performance in the target field.

Functional particles that improve electrical properties include metal nanoparticles (silver, gold, copper, nickel, cobalt, platinum, palladium, etc.), carbon-based materials (graphite, carbon black, carbon nanotubes, graphene, MXene, etc.), conductive polymers (PEDOT:PSS), and the like. These particles impart electrical conductivity to the porous structure and thus may be used in applications, such as electrodes, sensors, electronic devices, and the like. In particular, carbon nanotubes and graphene may simultaneously provide excellent electrical conductivity and mechanical strength, and thus are useful for developing flexible electronic devices.

Particles that improve thermal properties include hexagonal boron nitride, aluminum oxide, carbon-based materials, and the like, which may be applied to thermal management systems by improving thermal conductivity. Particles that enhance mechanical properties include silicon composites, silicon dioxide, titanium dioxide, carbon nanotubes, and the like, which may increase the strength and durability of the structure.

Particles that impart magnetic properties include magnetic nanoparticles, such as magnetite, which provide magnetic reactivity to the porous structure and thus may be used in applications such as actuators, drug delivery systems, magnetic separation, and the like. In addition, photocatalyst particles such as titanium dioxide and zinc oxide impart optical properties and catalytic activity and thus may be applied to environmental purification, optoelectronic devices, and the like.

These functional particles may be used alone or in combination, and the properties of the porous structure may be precisely controlled by adjusting the size, shape, concentration, dispersion state, and the like of the particles. In addition, it is important to optimize the interfacial properties of the functional particles and the polymer or polymer precursor, thereby preventing agglomeration of the particles and achieving uniform dispersion.

According to one embodiment of the present disclosure, the solid particles may be selected from the group consisting of sugar (sucrose) particles, sodium chloride (NaCl) particles, potassium chloride (KCl) particles, polystyrene, polymethylmethacrylate (PMMA), polyvinylalcohol (PVA), camphor, urea, citric acid, naphthalene cellulose nanocrystals, cellulose nanofibers, starch particles, chitin/chitosan microparticles, calcium carbonate, hydroxyapatite, silk fibroin microparticles, polylactic acid (PLA) particles, polycaprolactone microparticles, and combinations thereof, but are not limited thereto.

The solid particles used as the solid suspension phase may be composed of various kinds of materials, which may be broadly classified into water-soluble compounds, organic polymers, bio-derived materials, inorganic compounds, and the like. The solid particles are selected by considering the solubility with continuous media, interaction with surface wetting liquids, ease of removal through solvents, the possibility to adjust shape and size, and the like.

Sugar (sucrose) particles in water-soluble compounds are most widely used because the sugar particles may be easily dissolved in water and removed without being dissolved in a hydrophobic continuous medium such as PDMS. Similarly, salts such as sodium chloride (NaCl) and potassium chloride (KCl) may also be used as templates based on water solubility. Citric acid and urea may be removed through heat treatment due to a relatively low melting point.

Organic polymers such as polystyrene, polymethyl methacrylate (PMMA), polyvinyl alcohol (PVA), and the like may be selectively dissolved in a specific organic solvent, and thus may be selected as a suitable template material depending on the characteristics of the continuous medium. In addition, polylactic acid (PLA) and polycaprolactone microparticles are biodegradable polymers and are useful for fabricating porous structures for biological applications.

Camphor and naphthalene have the characteristic of being sublimated at a relatively low temperature, and may be easily removed only by heat treatment and thus may be effectively used in an environment where solvent use is limited.

Cellulose nanocrystals and nanofibers, starch particles, chitin/chitosan microparticles, silk fibroin microparticles, and the like, which are bio-derived materials, are excellent in biocompatibility and may be provided in various shapes and sizes, and are suitable for applications in the biomedical field. These materials also have eco-friendly properties, which may contribute to the construction of sustainable material systems.

Calcium carbonate and hydroxyapatite, which are inorganic compounds, have the characteristic of being dissolved in a weak acid, and may be selectively removed through acid treatment. In particular, hydroxyapatite is a bone-like component and is a template material suitable for bone tissue engineering applications.

These various solid particles may precisely control the pore size, distribution, connectivity, and the like of a final porous structure by adjusting the size, shape, surface properties, and the like, and two or more particles may also be mixed to form a layered porous structure.

According to one embodiment of the present disclosure, the surface wetting liquid may be selected from the group consisting of glycerol, ethylene glycol, propylene glycol, water, a surfactant, dimethyl carbonate (DMC), isopropyl alcohol (IPA), ethanol, acetone, dimethyl sulfoxide (DMSO), toluene, silicone oil, mineral oil, chloroform, hexane, heptane, fluorinated oils, and combinations thereof, but is not limited thereto.

The surface wetting liquid has excellent wettability with the solid particle surface and forms capillary bridges between the particles to play a key role in the rheological properties of ITPI and the formation of interconnections of the final porous structure. Such a surface-wetting liquid may have various physicochemical properties such as polarity, non-polarity, and mixing properties, and may be appropriately selected depending on the properties of the continuous medium and the solid particles.

Among polar solvents, glycerol is most widely used in PDMS-based ITPI with high viscosity and excellent wettability to sugar particles. Ethylene glycol and propylene glycol also have similar properties and are advantageous for stable capillary bridge formation due to higher viscosity than water. Water is the most common polar solvent, which is highly compatible with hydrophilic solid particles, and may also improve wettability to a hydrophobic surface, when used with surfactants.

The intermediate polar solvents include dimethyl carbonate, isopropyl alcohol, ethanol, acetone, and the like, which have relatively low viscosity and are advantageous for rapid capillary bridge formation, but are highly volatile and require attention to maintaining composition stability. Dimethylsulfoxide has excellent solubility in various materials and may be used in special applications.

Non-polar solvents include toluene, silicone oil, mineral oil, chloroform, hexane, heptane, and the like, which are excellent in compatibility with hydrophobic solid particles and exhibit immiscibility with water-soluble continuous media. In particular, silicone oils and mineral oils are advantageous for long-term use with low volatility and stable physical properties.

Fluorinated oils have unique properties without both hydrophobicity and oleophilicity, and may be used in applications where special surface interactions are required. This is particularly advantageous for interaction with solid particles having a fluorinated surface.

Surfactants are not added alone, but are added together with other surface wetting liquids to enhance wettability and are effective in modulating the interfacial properties between the solid particles and the continuous medium.

These various surface wetting liquids may be used alone or in combination, and the formation and properties of the capillary bridges may be precisely controlled by adjusting the type, amount, ratio, etc. of the liquid. As a result, an interconnection width, a distribution, mechanical properties, etc. of the final porous structure may be optimized according to a target application.

According to one embodiment of the present disclosure, the surface wetting liquid may further include functional particles selected from the group consisting of graphite, silicon-based composites, silver (Ag) nanoparticles, gold (Au) nanoparticles, copper (Cu) nanoparticles, nickel (Ni) nanoparticles, cobalt (Co) nanoparticles, platinum (Pt) nanoparticles, palladium (Pd) nanoparticles, silicon dioxide (SiO₂), titanium dioxide (TiO₂), aluminum oxide (Al₂O₃), zinc oxide (ZnO), zinc peroxide (ZnO₂), hexagonal boron nitride (BN), carbon black, carbon nanotubes (CNTs), graphene, magnetite (Fe₃O₄), MXene, conductive polymers (PEDOT:PSS), and combinations thereof, but is not limited thereto.

The surface wetting liquid may be added with various functional particles to enhance the physical, chemical, and electrical properties of the capillary bridges and impart additional functionality to the final porous structure. These functional particles are dispersed in the surface wetting liquid and act as some of the capillary bridges, and ultimately play an important role in determining the properties of the interconnections.

The functional particles dispersed in the surface wetting liquid may be fixed to a continuous medium during a curing process, or may optionally remain within the interconnections through a special process design. As a result, it is possible to control a spatial distribution of the functional particles in the porous structure and to intensively dispose the functional particles in positions where specific functions are required.

Functional particles that improve electrical properties include metal nanoparticles (silver, gold, copper, nickel, cobalt, platinum, palladium, etc.), carbon-based materials (graphite, carbon black, carbon nanotubes, graphene, MXene, etc.), conductive polymers (PEDOT:PSS), and the like. When these particles are dispersed in the surface wetting liquid, it is possible to form an electrically conductive network through the interconnections, which is advantageous for optimizing an electron transfer path. In particular, these properties are very important in applications such as battery electrodes, sensors, electronic devices, etc.

Inorganic oxide particles such as silicon dioxide, titanium dioxide, aluminum oxide, and zinc oxide may adjust the rheological properties of the surface wetting liquid and improve the mechanical strength. In addition, some of these particles may provide additional functionality, such as photocatalytic and antibacterial properties, and thus may be effectively used in environmental and medical applications.

Magnetite, which are magnetic particles, imparts magnetic reactivity to the surface wetting liquid and may form capillary bridges that react with an external magnetic field. The magnetite enables the fabrication of a self-controllable porous structure and may be applied to actuators, sensors, drug delivery systems, etc.

Hexagonal boron nitride is a material having both excellent thermal conductivity and electrical insulation, and may be used to optimize a thermal path in electronic devices or battery systems in which thermal management is important.

These functional particles may be used alone or in combination, and the rheological and functional properties of the surface wetting liquid may be precisely controlled by adjusting the size, shape, concentration, surface treatment, and the like of the particles. In particular, nanometer-sized particles may result in effective functional improvement in a small amount due to a large surface area to volume ratio, but may require additional treatment for agglomeration prevention and uniform dispersion.

According to one embodiment of the present disclosure, the solid particles may be included in an amount of 30 vol % to 90 vol % with respect to the total composition of the interconnection-tunable porous ink, but are not limited thereto.

The content of the solid particles may be adjusted in the range from 30 vol % to 90 vol % with respect to the total composition of the ITPI. This range provides conditions under which the solid particles may maintain stable rheological properties during the 3D printing process while forming adequate porosity in the final porous structure. When the content of solid particles is less than 30 vol %, the porosity is low and a higher amount of surface wetting liquid may be required for interconnection. On the other hand, when the content is more than 90 vol %, the particle surface becomes excessively wet with only a small amount of surface wetting liquid, so that the liquid exceeding local agglomeration between the particles may remain in a separated form in the structure.

According to one embodiment of the present disclosure, a volume ratio (R) of the surface wetting liquid to the volume of the solid particles represented by the following Equation 1 may be 0.1 vol % to 70 vol %, but is not limited thereto:

$$R ( vol \% ) = \frac{Volume of surface wetting liquid}{\begin{matrix}Volume of solid particles + \\ Volume of surface wetting liquid\end{matrix}} \times 100 \qquad [ Equation 1 ]$$

The volume ratio (R) of the surface wetting liquid to the volume of the solid particles represented by Equation 1 may be adjusted in the range of 0.1 vol % to 70 vol %. This range provides conditions under which the surface wetting liquid may prevent structural instability due to excessive liquid phase formation even while forming suitable capillary bridges between the solid particles. When the R is less than 0.1 vol %, capillary bridge formation may be insufficient and the interconnection structure may not be properly formed. On the other hand, when the R is more than 70 vol %, the solid particles may be excessively exposed to the surface wetting liquid, causing the capillary bridges to be broken and the structural linkage to be lost.

According to one embodiment of the present disclosure, the solid particles may have a diameter of 0.1 μm to 1000 μm, but are not limited thereto.

The size of the solid particles may be adjusted in the range of 0.1 μm to 1000 μm. The size of the solid particles directly affects the size of pores formed in the final porous structure. The larger the particle size, the larger the size of the pores formed, and thus an interconnection width is also affected. The particle sizes in the range of 0.1 μm to 1000 μm may provide suitable pore sizes for various applications, which may satisfy various functional requirements related to mass transfer, fluid flow, structural rigidity, and the like.

According to one embodiment of the present disclosure, the interconnection-tunable porous ink may have a yield stress of 200 Pa or more, but is not limited thereto.

The ITPI may have a yield stress of 200 Pa or more. The yield stress refers to a level of stress at which a material begins plastic deformation and is directly related to the ability of the structure to maintain its shape without being deformed by a self-weight during the 3D printing process. The yield stress of 200 Pa or higher allows the ITPI to form and maintain a stable structure upon 3D printing. The yield stress plays an important role in preventing interlayer collapse or deformation, particularly when fabricating a complex 3D structure.

According to one embodiment of the present disclosure, the interconnection-tunable porous ink may exhibit a liquid-like behavior under a shear stress higher than a yield stress of the interconnection-tunable porous ink, and may exhibit a solid-like behavior under a shear stress lower than the yield stress of the interconnection-tunable porous ink, but is not limited thereto.

The ITPI exhibits two different behaviors based on the yield stress. When the shear stress higher than the yield stress is applied, the ITPI exhibits a liquid-like flow behavior and may be smoothly extruded through nozzles. On the other hand, under the shear stress lower than the yield stress, the ITPI exhibits a solid-like behavior, and the shape may be stably maintained after extrusion. Such a property is known as a thixotropic behavior and is a rheological property suitable for 3D printing. The thixotropic behavior allows the ITPI to be easily extruded through the nozzles during printing, while quickly maintaining its shape through structural recovery immediately after extrusion.

Further, a second aspect of the present disclosure provides a 3D printing method using the interconnection-tunable porous ink according to the first aspect of the present disclosure, the method including: ejecting the interconnection-tunable porous ink through a 3D printer to form a structure having a predetermined shape; curing the structure; and removing the solid particles and the surface wetting liquid, in which pores are formed in the structure by removing the solid particles, and interconnections are formed in the structure by removing capillary bridges formed of the surface wetting liquid.

With respect to the 3D printing method according to the second aspect of the present disclosure, the detailed description of parts duplicated with the first aspect of the present disclosure has been omitted, but even if the description has been omitted, the contents disclosed in the first aspect of the present disclosure may be equally applied to the second aspect of the present disclosure.

The 3D printing method according to the present disclosure includes a process of fabricating a porous structure having a controlled interconnection width using ITPI. The method consists largely of three main steps.

First, ITPI is ejected through nozzles of the 3D printer to form a structure having a desired shape. The thixotropic property of ITPI plays an important role in this process. Under a high shear stress, the ITPI flows like a liquid and is easily extruded through the nozzles, and quickly transitions to a solid-like behavior in a low shear stress environment after extrusion to maintain structural stability.

Second, the formed structure is solidified through a process of thermal curing, photocuring or auto-curing. In this step, the polymer or polymer precursor, which is a continuous medium, is crosslinked to stabilize the framework of the structure.

Third, the solid particles and the surface wetting liquid are removed through solvent washing. When the solid particles are removed, pores are formed at the removed sites, and when the capillary bridges formed from the surface wetting liquid are removed, interconnections are generated. Through this process, a porous structure with controlled porosity and interconnection width is finally completed.

In particular, the greatest feature of the method is that the interconnection width may be precisely controlled by adjusting the content of the surface wetting liquid. In addition, the size of the pores is also controllable by adjusting the size of the solid particles.

According to one embodiment of the present disclosure, the curing step may be performed through a thermal curing, photocuring or auto-curing process, but is not limited thereto.

The curing step of the 3D printing method may be performed by a thermal curing, photocuring or auto-curing process. The thermal curing method is a method of promoting a crosslinking reaction of a polymer or polymer precursor through an external heat source, and generally includes a process of heating in a specific temperature range (for example, about 70° C. in the case of PDMS) for a predetermined time (about 1 hour). The photocuring method is a method of inducing a polymerization reaction of a polymer or polymer precursor containing a photoinitiator using light having a specific wavelength, such as ultraviolet (UV) or visible light, and has an advantage of enabling a fast curing rate and precise control of a curing site. The method is particularly effective when using photoreactive prepolymers such as acrylate-based resins, PEGDA, and HEMA, and is advantageous for fabrication of a high-resolution microstructure. The auto-curing method is a method in which curing is performed through a chemical reaction at room temperature, and the curing is naturally performed over time without a separate heat source. Depending on the type and property of the polymer or polymer precursor used, a suitable curing method may be selected, which may affect the physical and chemical properties of the final porous structure.

According to one embodiment of the present disclosure, the step of removing the solid particles and the surface wetting liquid may be performed by solvent washing or sublimation/vaporization, but is not limited thereto.

The step of removing the solid particles and the surface wetting liquid may be performed by solvent washing or sublimation/vaporization. The solvent washing method is a method in which the cured structure is immersed in an appropriate solvent or washed away with a flowing solvent to dissolve and remove the solid particles and the surface wetting liquid. In particular, in the case of using water-soluble materials such as sugar particles and glycerol, water may be used as a solvent for simple washing. Salts such as sodium chloride and potassium chloride may also be easily dissolved in water and removed. When polymer particles such as polystyrene or PMMA are used, the polymer particles may be selectively removed using an organic solvent such as acetone or toluene. In this process, when the solid particles and the surface wetting liquid are dissolved in the solvent and removed, pores and interconnections are formed at the removed sites, respectively. Suitable solvents may be selected depending on the properties of the used materials, which may affect the washing efficiency and the quality of the final structure.

The sublimation/vaporization method is a method in which heat is applied to directly convert the solid particles or surface wetting liquid into a gaseous state and remove the solid particles or surface wetting liquid. It is effective when a highly sublimable material such as camphor or naphthalene is used as the solid particles, or a highly volatile material such as ethanol or acetone is used as the surface wetting liquid. The method is particularly useful when complete removal of the solvent is difficult in environments where solvent use is limited or in complex internal structures. The sublimation/vaporization process is generally performed by adjusting a temperature under vacuum conditions, and in this process, when solid particles or a surface wetting liquid are converted to a gaseous state and removed, pores and interconnections are formed at the removed sites, respectively.

According to one embodiment of the present disclosure, the diameter of the interconnection may be controlled by adjusting the concentration of the surface wetting liquid contained in the interconnection-tunable porous ink, but is not limited thereto.

The diameter of the interconnection may be precisely controlled by adjusting the concentration of the surface wetting liquid contained in the ITPI. As the concentration of the surface wetting liquid increases, the size and number of capillary bridges formed increase, and as a result, wider interconnections are formed. In particular, when there is no surface wetting liquid, no interparticle capillary bridges are formed and thus no interconnected structure is shown. This means that the surface wetting liquid is a key factor which enables the formation and precise control of the connection structure, beyond simple inter-particle spacing adjustment.

According to one embodiment of the present disclosure, the interconnections may have a diameter of 0.01 μm to 100 μm, but is not limited thereto.

The interconnections of the porous structure fabricated by the process according to the present disclosure may have a diameter in the range of 0.01 μm to 100 μm. This range may be achieved by adjusting the concentration of the surface wetting liquid, and generally, as the concentration of surface wetting liquid increases, the connection width also increases. The interconnection width directly affects various functional properties of the porous structure, such as fluid flow, mass transfer, mechanical properties, and the like. In particular, the interconnection width in the range of 0.01 to 100 μm may act as an optimal range to meet the functions of selective material permeation, pressure sensitivity, fluid control, and the like required in various applications.

According to one embodiment of the present disclosure, the size of the pores may be controlled by adjusting the size of the solid particles included in the interconnection-tunable porous ink, but is not limited thereto.

The pore size of the final porous structure may be controlled by adjusting the size of the solid particles included in the ITPI. The solid particles serve as a sacrificial template, and thus when the solid particles are removed in the solvent washing process after curing, pores are formed in the removed sites. Accordingly, the size of the solid particles used has a direct correlation with the size of the pores formed. The larger the solid particles used, the larger the pores formed, and the smaller the particles used, the smaller the pores formed. These properties may be used to fabricate a porous structure with optimal pore sizes for application purposes.

According to one embodiment of the present disclosure, the pores may have a diameter of 0.1 μm to 1000 μm, but are not limited thereto.

The pores of the porous structure fabricated by the method according to the present disclosure may have a diameter in the range of 0.1 μm to 1000 μm. This range is directly related to the size of the solid particles used, and the size of the solid particles is adjusted and thus the size of the pores may also be adjusted in response to the size of the solid particles. The size of the pores affects the mechanical strength, permeability, absorption properties, etc. of the porous structure, and the pore size in the range of 0.1 to 1000 μm may provide properties suitable for various applications. In particular, the pore size in this range is suitable for functions such as fluid flow control, selective material absorption, pressure sensing, etc., and may meet the requirements of various applications.

In addition, a third aspect of the present disclosure provides a porous structure fabricated by the 3D printing method according to the second aspect of the present disclosure.

With respect to the porous structure according to the third aspect of the present disclosure, the detailed description of parts duplicated with the second aspect of the present disclosure has been omitted, but even if the description has been omitted, the contents disclosed in the second aspect of the present disclosure may be equally applied to the third aspect of the present disclosure.

A third aspect of the present disclosure provides a porous structure fabricated by the 3D printing method described above. This porous structure has the property that an interconnection width is precisely controlled. In particular, it is possible to precisely control the interconnection width in the range of 5 to 45 μm by adjusting the concentration of the surface wetting liquid, and to control the size of the pores in the range of 30 to 500 μm by adjusting the size of the solid particles.

Such a porous structure has excellent mechanical properties. In particular, the porous structure may be compressed without structural damage even under a high strain rate of up to 90%, and has an elastic property of being quickly restored to its original shape after load removal. In addition, the porous structure exhibits a property of maintaining excellent durability and form stability even under repeated compression.

Such a precisely controlled porous structure and excellent mechanical properties may be effectively used in a variety of applications, including soft robotics, microfluidic systems, filtration and purification systems, energy storage devices, sensors, and the like.

In addition, a fourth aspect of the present disclosure provides an oil-water separation system, including the porous structure according to the third aspect of the present disclosure.

With respect to the oil-water separation system according to the fourth aspect of the present disclosure, the detailed description of parts duplicated with the third aspect of the present disclosure has been omitted, but even if the description has been omitted, the contents disclosed in the third aspect of the present disclosure may be equally applied to the fourth aspect of the present disclosure.

The fourth aspect of the present disclosure provides an oil-water separation system using the porous structure described above. A porous structure formed of polymers with hydrophobic and oleophilic properties, such as PDMS, has the property of being able to selectively absorb only oil in a water/oil mixed environment. Such properties may be effectively used in the oil-water separation system.

In particular, the porous structure according to the present disclosure may optimize oil absorption performance through the advantage of being able to precisely control the interconnection width. As the interconnection width increases, the mechanical strength of the structure is reduced, so that the structure swells more easily when oil is absorbed, and the amount of absorption increases. In addition, such a porous structure has the advantage of being reusable by repeatedly absorbing the oil and discharging the oil through physical compression.

These properties may provide effective solutions in various environmental purification applications, including marine pollution prevention, industrial wastewater treatment, and oil spill incident response.

In addition, a fifth aspect of the present disclosure provides a pressure sensor, including the porous structure according to the third aspect of the present disclosure.

With respect to the pressure sensor according to the fifth aspect of the present disclosure, the detailed description of parts duplicated with the third aspect of the present disclosure has been omitted, but even if the description has been omitted, the contents disclosed in the third aspect of the present disclosure may be equally applied to the fifth aspect of the present disclosure.

The fifth aspect of the present disclosure provides a pressure sensor using the porous structure described above. In particular, the pressure sensor may be used as a sensor capable of measuring a change in resistance according to an external pressure by filling the inside of the porous structure with a liquid metal (LM) to impart conductivity.

The porous structure filled with the liquid metal exhibits properties in which resistance varies depending on various external stimuli, such as tensile, bending, pressure, and the like. In particular, the porous structure shows a sensitive response to pressure stimulation, which is because an internal conduction path is deformed while the pores in the structure shrink by pressure. Such a property is based on which the porous structure may be used as the pressure sensor.

The porous structure according to the present disclosure may adjust sensitivity and the measurement range of the pressure sensor through the advantage of being able to precisely control the interconnection width. In particular, the wider the interconnection width, the easier the filling of the liquid metal, and the more easily the structural deformation due to pressure occurs, thereby exhibiting high sensitivity.

Such a pressure sensor may be used in various applications, including medical devices, wearable devices, soft robotics, human-machine interfaces, and the like.

In addition, a sixth aspect of the present disclosure provides a battery electrode including the porous structure according to the third aspect of the present disclosure.

With respect to the battery electrode according to the sixth aspect of the present disclosure, the detailed description of parts duplicated with the third aspect of the present disclosure has been omitted, but even if the description has been omitted, the contents disclosed in the third aspect of the present disclosure may be equally applied to the sixth aspect of the present disclosure.

The porous structure according to the present disclosure may be effectively used in fabrication of battery electrodes by using the property of being able to precisely control the interconnection width. The battery electrode is a structure in which an internal pore network plays an important role for efficient movement of ions and electrons, and the controlled interconnection structure may optimize an ion movement path and improve electrochemical performance.

A porous structure-based battery electrode may impart electrical conductivity by adding conductive particles (e.g., graphite, carbon nanotubes, graphene, metal nanoparticles, etc.) to the polymer or polymer precursor. The interconnection width may be controlled to optimize the penetration of an electrolyte and an ion diffusion path, which may improve key performance indicators such as the charge/discharge rate, capacity retention, cycle life, etc. of the battery.

In particular, it is possible to fabricate electrodes of a complex three-dimensional structure by using the 3D printing method according to the present disclosure, thereby increasing the loading amount of active material per unit volume and maximizing an electrode-electrolyte interface area. In addition, precise control of the pore size and interconnection width may optimize stress distribution in the electrode, thereby improving structural stability for a volume change occurring during charging and discharging.

Such a porous structure-based battery electrode may be applied to various energy storage devices, such as lithium-ion batteries, sodium-ion batteries, metal-air batteries, supercapacitors, and the like, and particularly, may be effectively used in applications required with both high energy density and high output density.

Hereinafter, the present disclosure will be described in more detail with reference to the following Examples, but the following Examples are only for illustrative purposes and are not intended to limit the scope of the present disclosure.

### [Example 1] Preparation of PDMS-Based ITPI (p-ITPI)

In order to demonstrate the experimental validity of an ITPI concept, in Example 1, PDMS-based ITPI (p-ITPI) was prepared by combining polydimethylsiloxane (PDMS) as a continuous medium, sugar particles which were insoluble in PDMS as a solid suspension phase, and glycerol which was immiscible with PDMS and insoluble with sugar particles as a surface-wetting liquid phase, but had a surface contact angle of less than 90°.

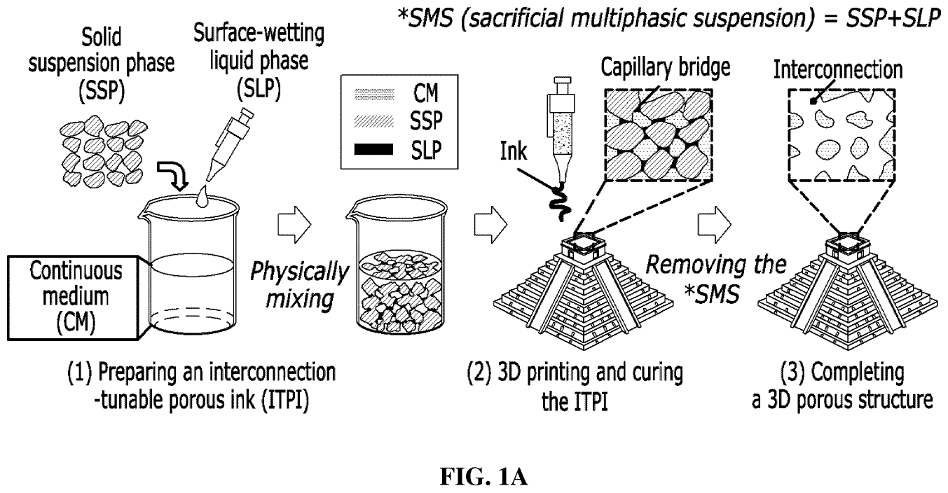

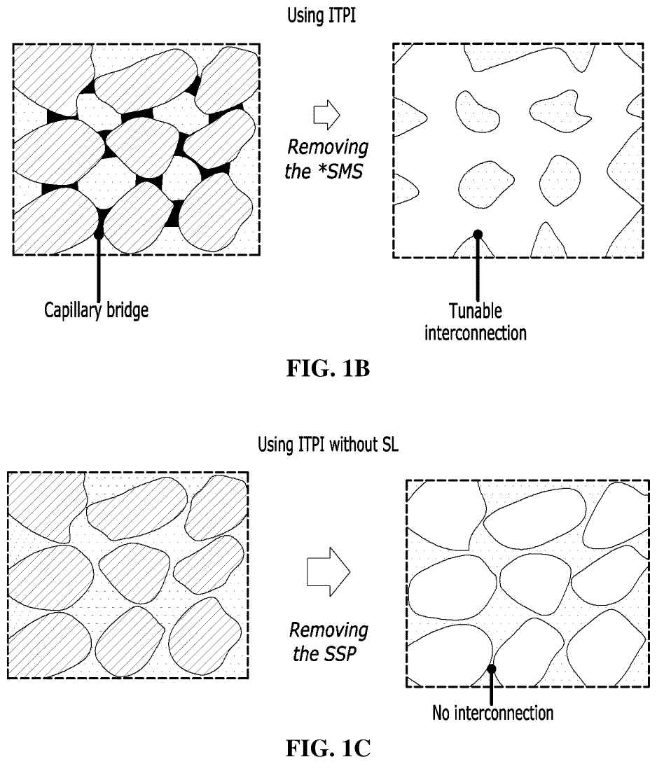

As shown in FIG. 1, the overall conceptual flow of fabricating an ITPI-based porous structure was as follows. First, a continuous medium, a solid suspension phase, and a surface-wetting liquid phase were mixed at a predetermined ratio to prepare an ITPI (FIG. 1A). During the preparation, the surface wetting liquid formed capillary bridges on the surface of the solid particles and induced agglomeration between the particles so that the solid particles attracted each other to form a concentrated multiphase structure, and as a result, this structure acted as a sacrificial multiphasic suspension (SMS).

Specifically, p-ITPI was prepared by mechanically mixing PDMS prepolymer, sugar particles (about 30 μm), and glycerol. The mixing ratio was adjusted in the range of 60 vol % of sugar particles and 5 to 20 vol % of glycerol based on the PDMS prepolymer.

### [Example 2] Fabrication of Porous PDMS Structure Using p-ITPI

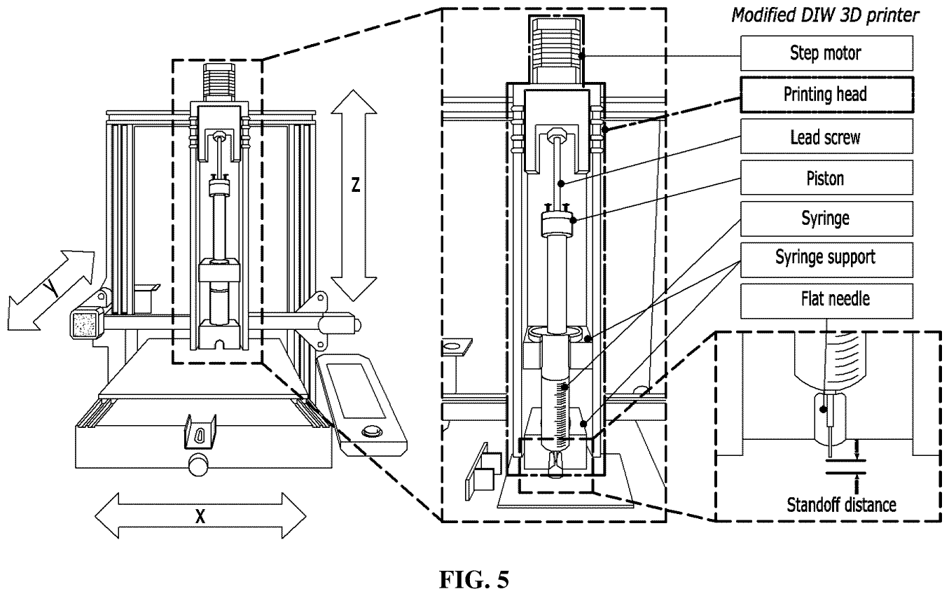

To verify the actual stackability and structural stability of p-ITPI, a 3D porous PDMS structure was fabricated by applying a direct ink writing (DIW) process based on a viscoelastic paste. A syringe/needle microdeposition technique was used as the printing method, and a printing head of a commercial 3D printer was modified to construct a system (FIG. 5).

A DIW 3D printer system illustrated in FIG. 5 applied a rotational-linear motion conversion mechanism based on a step motor, a lead screw, and a piston. For stable ejection of ink, a bracket capable of firmly fixing a syringe body and a blade was fabricated and structurally integrated, and various flat needles of 16 to 18 gauges were selectively used depending on the physical properties of the ink and the printing purpose.

In the case of p-ITPI composed of 60 vol % of sugar particles and 10 vol % of glycerol, conditions of X and Y-axis movement speeds of 2 mm/s, a Z-axis movement speed of 11.25 mm/s, an ink ejection speed of 2.5 mm/s, a filament diameter 1.24 mm, and a standoff distance of 1.25 mm were used as the optimal printing conditions based on a 16 gauge flat needle.

The prepared p-ITPI was stacked on a glass substrate in a desired shape through nozzles, and then crosslinked with a PDMS prepolymer, which was a continuous medium, through a thermal curing process at 70° C. for about 1 hour. Thereafter, SMS composed of sugar particles and glycerol was removed using water to complete a flexible and elastic 3D porous PDMS structure composed of porous microfilaments (FIG. 1B).

### [Comparative Example 1] Preparation of Porous Ink without Surface Wetting Liquid

In Comparative Example, a porous ink excluding a surface wetting liquid was prepared. An ink was prepared by mixing only 60 vol % of sugar particles (about 30 μm) in the PDMS prepolymer. The prepared ink was fabricated into a porous PDMS structure through 3D printing, curing and washing processes in the same manner as in Example 2 (FIG. 1C). As illustrated in FIG. 1C, no interconnected structure was formed in the structure fabricated of the ink excluding the surface-wetting liquid phase.

### [Experimental Example 1] Analysis of Viscoelastic Property of p-ITPI

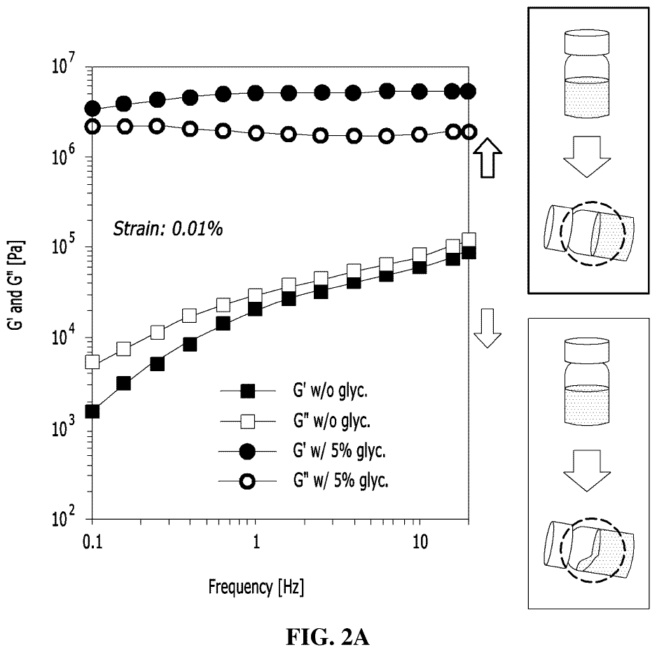

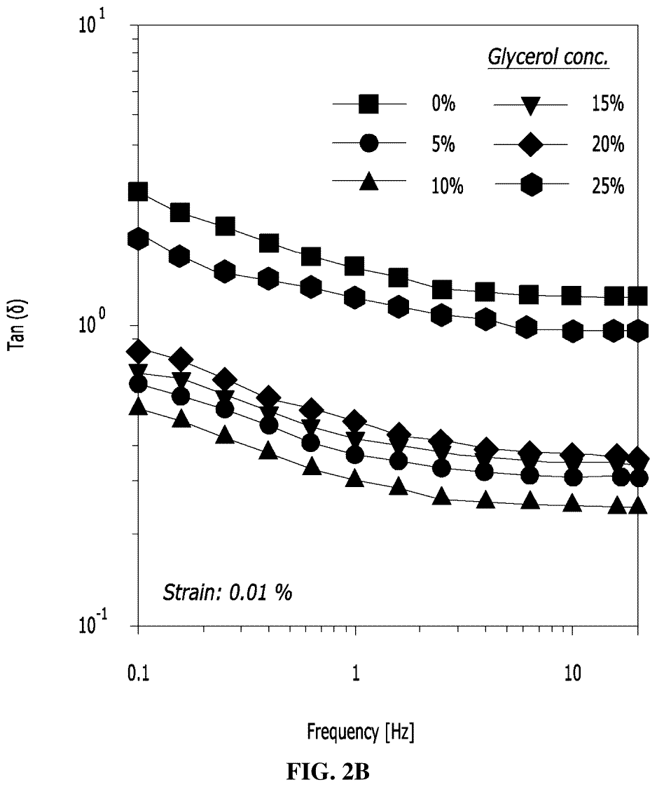

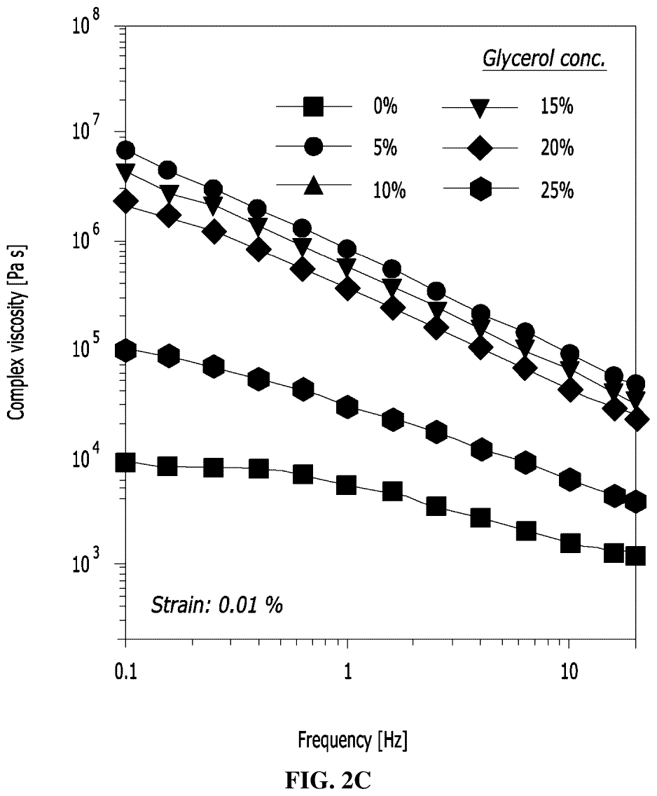

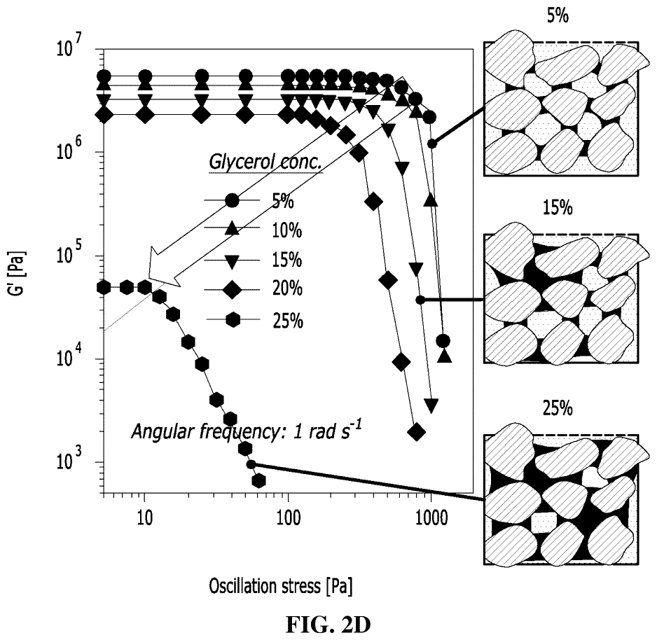

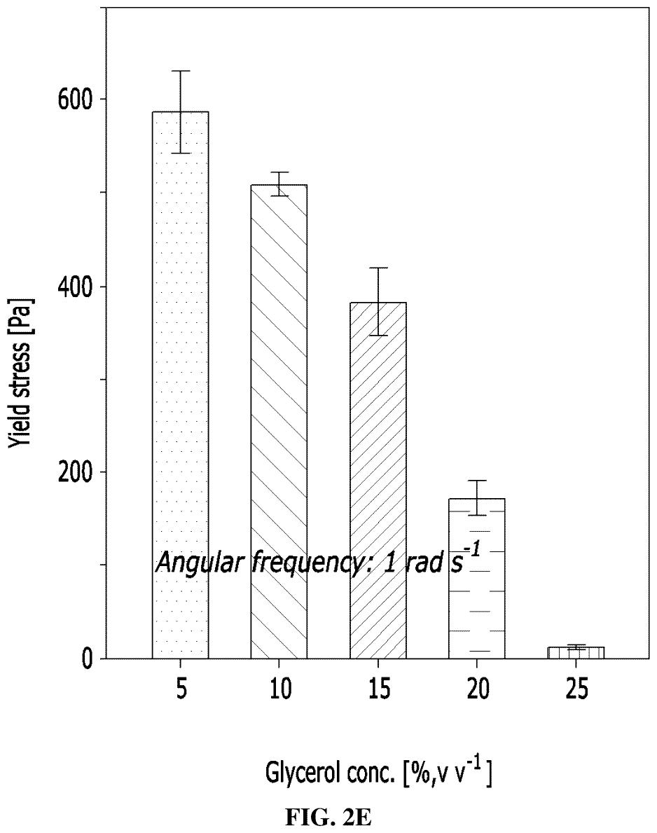

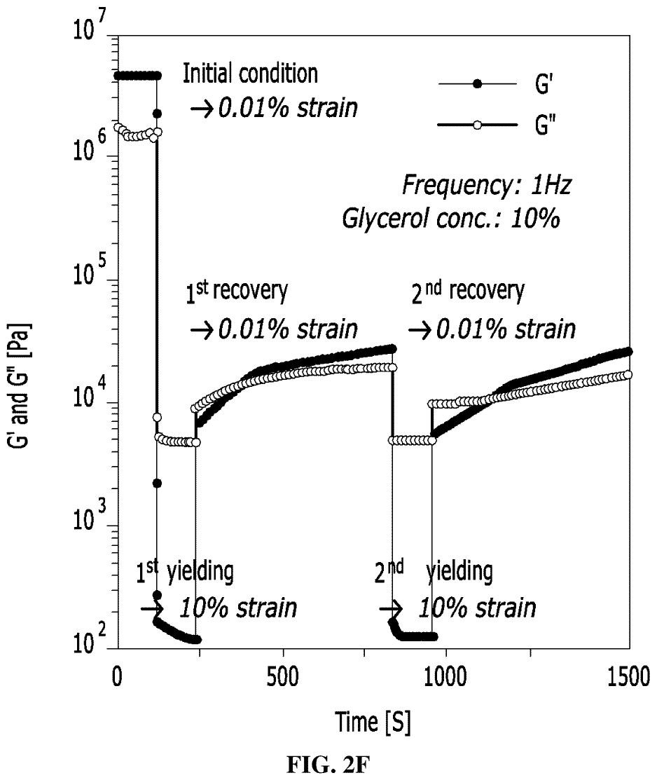

In order to quantitatively analyze the viscoelastic property of p-ITPI, a dynamic oscillation property was measured in Experimental Example 1. To determine an effect of the addition of a surface wetting liquid on the rheological behavior of an ink, small amplitude oscillatory shear was measured by comparing compositions with and without the addition of 5 vol % glycerol to a PDMS prepolymer mixture containing 60 vol % sugar particles (about 30 μm) (FIG. 2A).

As illustrated in FIG. 2A, when glycerol was not added, a storage modulus G′ was lower than a loss modulus G″, and both G′ and G″ showed a fluid-like behavior with a large change according to a frequency. On the other hand, when glycerol was added, by capillary bridges formed between sugar particles, G′ was higher than G″ and tan (δ) (=G″/G′) was less than 1, which indicated that a solid-like elastic property was superior. At the same time, it was confirmed that the frequency dependence of the two dynamic moduli also decreased, and thus the structural stability was enhanced.

Thereafter, as a result of analyzing a rheological change of p-ITPI according to a change in glycerol content (5 to 25 vol %), as shown in FIG. 2B, tan (δ) recorded the lowest value when 10 vol % was added, and then as the glycerol content increased, tan (δ) gradually increased to exceed 1 at 25 vol %. This conversion means that the ink was gradually liquefied, and the liquid behavior became dominant, which was interpreted because the sugar particles were gradually saturated as the glycerol concentration increased and then the capillary bridge formation was suppressed.

A result of measuring the complex viscosity illustrated in FIG. 2C also showed a similar trend thereto, and the viscosity in 10 vol % glycerol was highest and then decreased again. This result reflected an increase in viscosity when capillary bridge formation was most active, and then suggested that the structural linkage was weakened.

Furthermore, the yield property of p-ITPI according to a change in glycerol content was also evaluated (FIGS. 2D and 2E). In all compositions, p-ITPI showed gel properties close to a solid at a low shear stress, and yielding occurred at a high shear stress. As illustrated in FIGS. 2D and 2E, both the yield stress and the storage modulus gradually decreased as the glycerol content increased from 5 to 20 vol %, but still maintained high values of yield stress >200 Pa and G′>2×10⁶ Pa, which showed that structural stability was ensured. However, at a glycerol content of 25 vol % or more, the yield stress and G′ rapidly decreased, which was interpreted as a result of excessive exposure of sugar particles to glycerol inside a multiphase suspension, resulting in breakdown of the capillary bridges and loss of structural linkage.

To quantitatively confirm a thixotropic behavior of p-ITPI, repeated shear experiments were performed on a 10 vol % glycerol composition (FIG. 2F). In the corresponding experiment, a process of inducing extrusion for 2 minutes under a high shear stress (10% strain) and then recovering for 10 minutes under a low shear stress (0.01% strain) was repeatedly measured. As illustrated in FIG. 2F, p-ITPI was easily extruded with a liquid-like flowing property (G″>G′) under a high shear stress, and recovered to a solid-like property (G′>G″) again under a low shear stress to maintain its form. In particular, the positions of the glycerol and sugar particles were rearranged and the structure was reshaped in a recovery section after the first yield, and as a result, it was shown that a dynamic modulus was recovered to about 95% of the initial G′ level from the second yield.

### [Experimental Example 2] Microstructural Analysis of Porous PDMS Structure

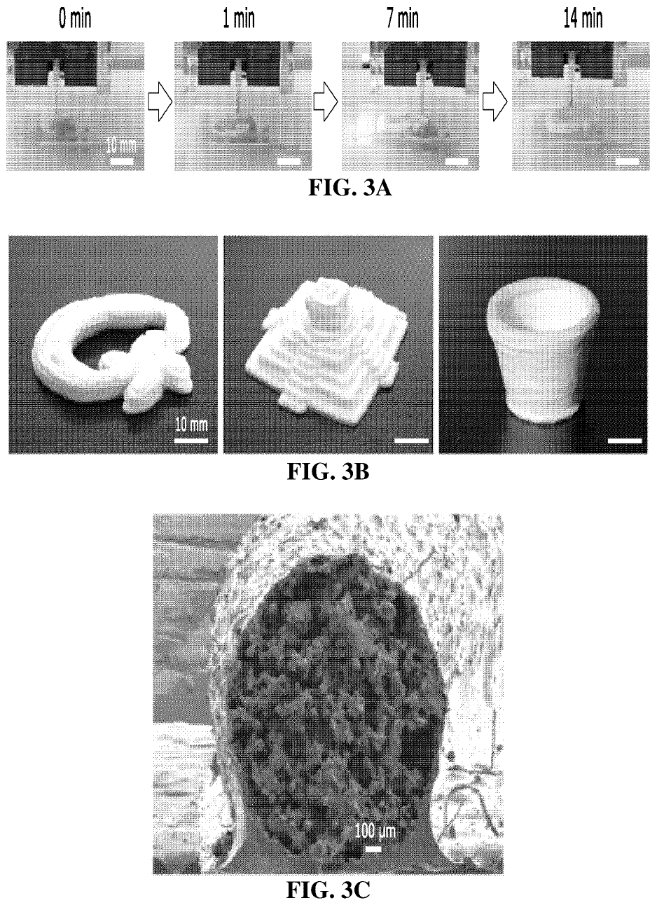

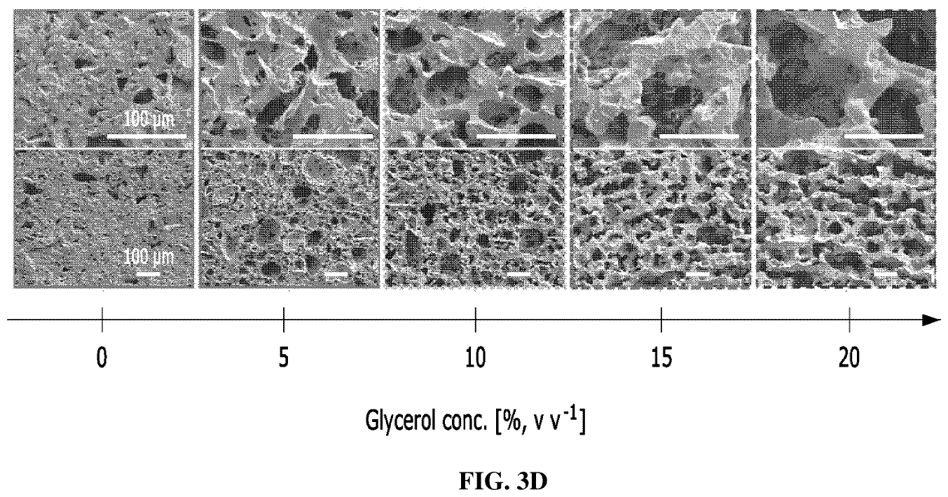

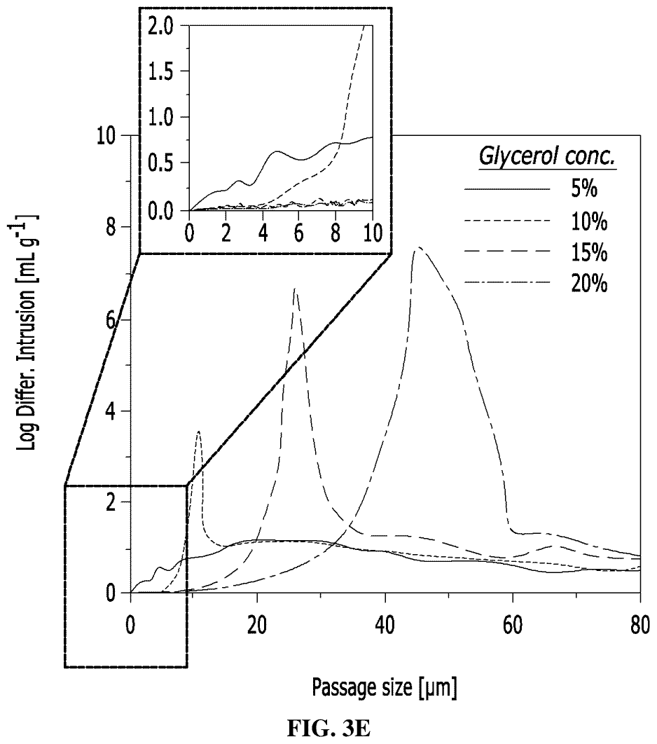

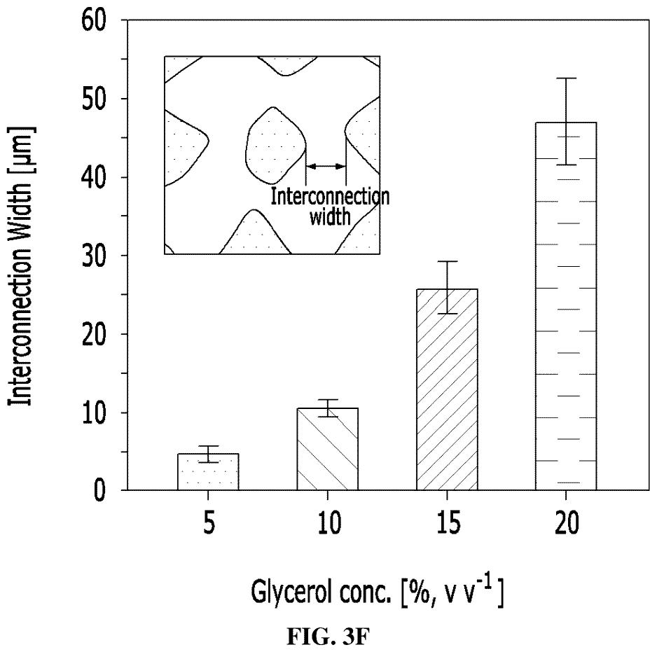

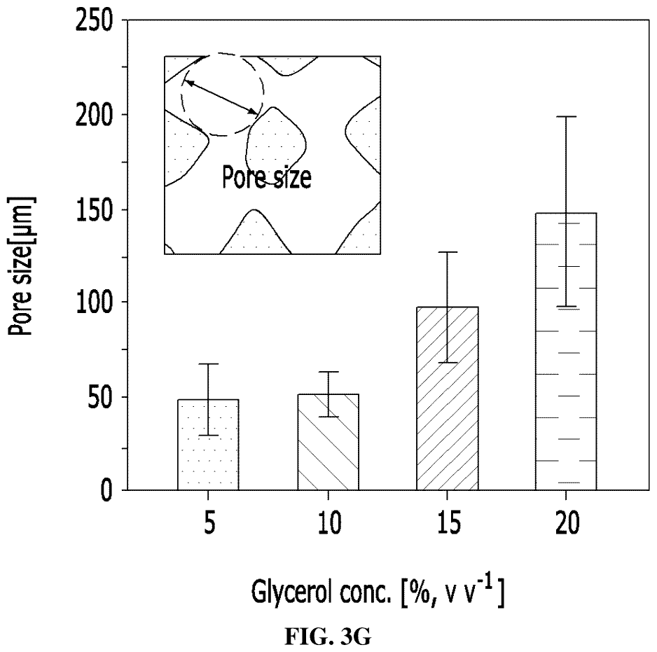

A microstructure of the fabricated porous PDMS structure was analyzed by scanning electron microscopy (SEM) and mercury porosity measurement. As illustrated in FIG. 3B, porous PDMS structures having various shapes such as logo, Chichen Itza's pyramid, and bowl shapes were successfully fabricated using p-ITPI. FIG. 3C shows a cross-sectional image of a printed porous filament.

As can be observed from an SEM image shown in FIG. 3D, a specimen (Comparative Example 1) made by p-ITPI without adding glycerol had almost no interconnection formed. On the other hand, in the case of a specimen made by p-ITPI added with glycerol, it can be seen that the interconnections were stably formed, and the size of the connection significantly increased as the glycerol concentration increased.

As a result of measuring the mercury porosity shown in FIGS. 3E and 3F, the interconnection width showed a tendency to increase from about 5 μm (5 vol %) to a maximum of 45 μm (20 vol %) depending on a glycerol concentration. As shown in FIG. 3G, the pore size was maintained at a level of about 50 μm at 5 to 10 vol % glycerol concentrations, but expanded to about 100 to 150 μm at 15 to 20 vol %. It was shown that glycerol formed mainly capillary bridges at a low concentration to adjust only the connection width, whereas at a high concentration, the sugar particles were saturated to also induce expansion of the pore size itself.

### [Experimental Example 3] Analysis of Effect of Sugar Particles and Glycerol Contents

An effect of the contents of sugar particles and glycerol on formation of a porous structure was systematically analyzed. While the sugar particle size was fixed at 30 μm, the sugar content (50 to 80 vol %) and the glycerol content (5 to 40 vol %) were changed, and the possibility of structure formation and microstructural characteristics were evaluated.

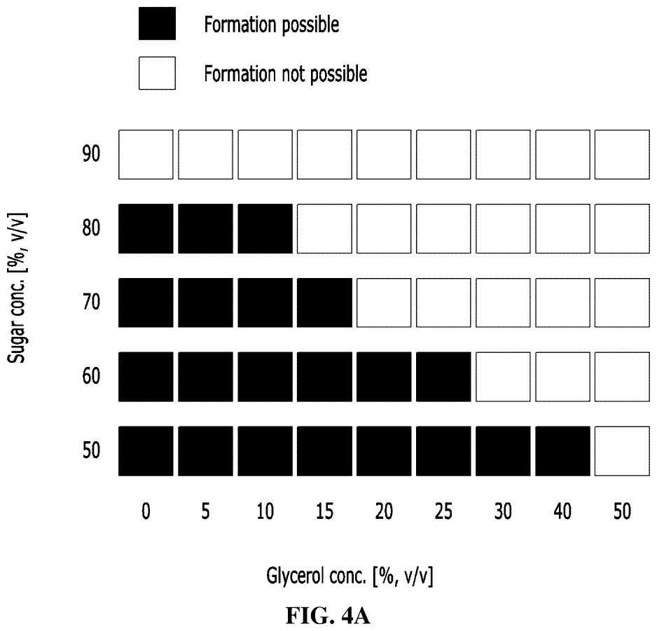

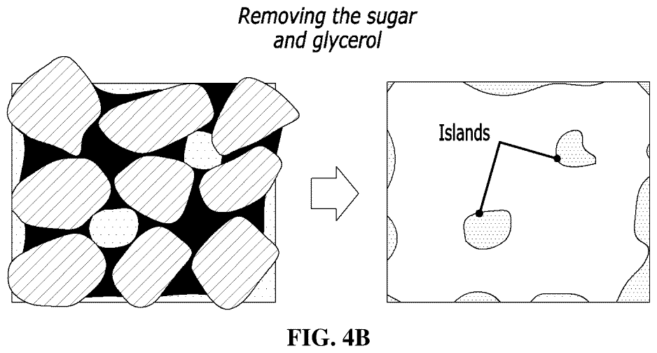

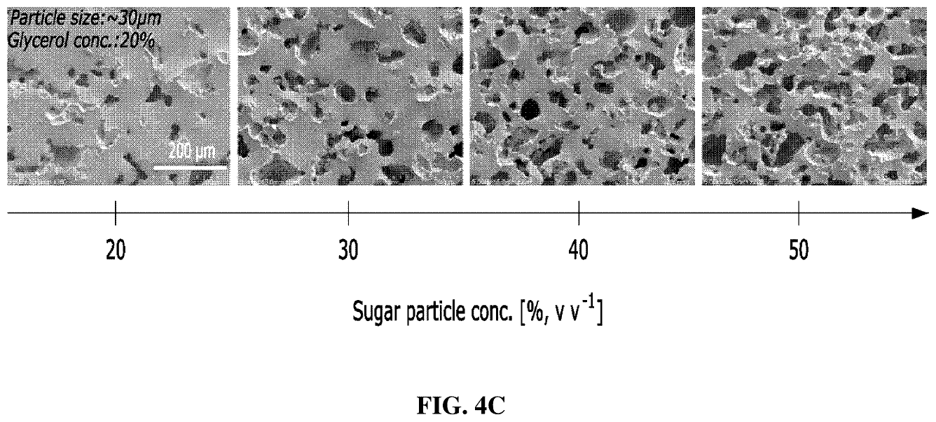

As illustrated in FIG. 4A, as the sugar content increased from 50 vol % to 80 vol %, it was confirmed that a glycerol concentration range in which the structure formation was enabled tended to be gradually narrowed. This was because the surface of the particles became excessively wet with only a small amount of glycerol in a high concentration sugar environment, and glycerol exceeding local agglomeration (capillary bridges) between the particles remained as a PDMS mass in the form of islands in the structure.

As illustrated in FIG. 4B, when the glycerol and sugar were removed after curing at the sugar content of 70 vol % or more, a large amount of island-shaped PDMS remained so that a desired porous structure was not realized. Conversely, as illustrated in FIG. 4C, it was found that when the sugar content was 50 vol % or less, structure formation was enabled even if the glycerol content was adjusted to a relatively wide range, but the overall porosity was low and a larger amount of glycerol was required for interconnection.

### [Experimental Example 4] Evaluation of Independent Adjustability of Interconnection Width

The possibility to adjust the interconnection width independently of the pore size in a porous structure made by p-ITPI (Example 3) with 50 vol % of the sugar particle content was evaluated.

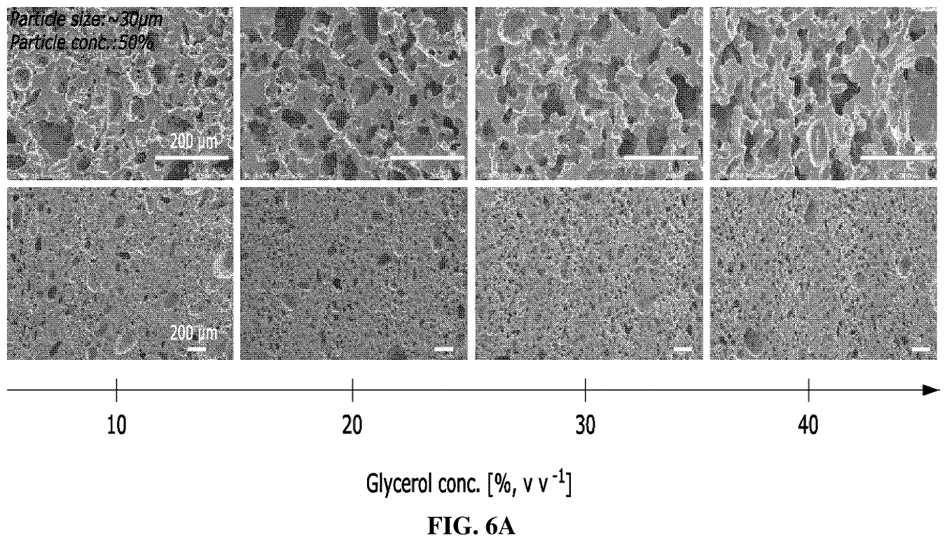

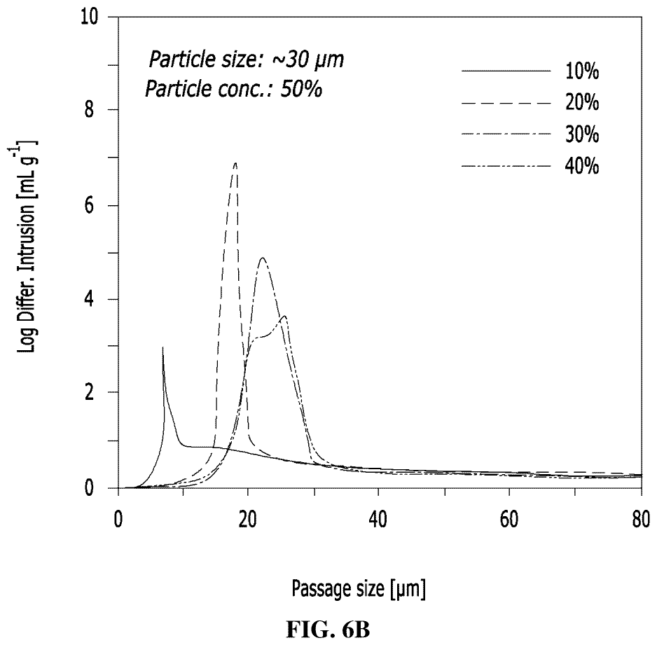

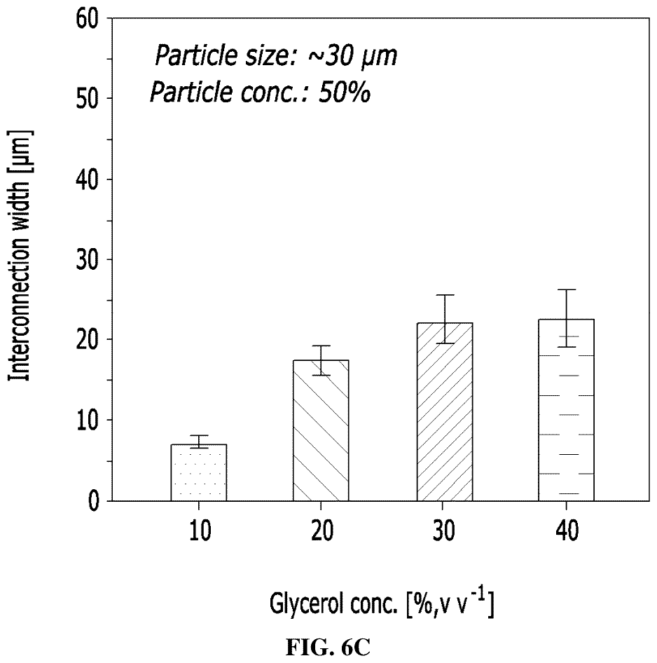

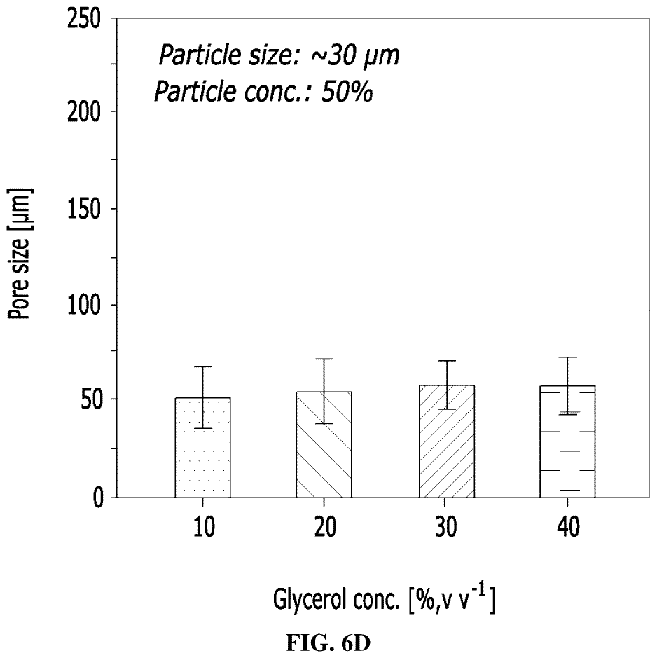

As can be observed from the SEM image shown in FIG. 6A, the interconnection was stably formed when glycerol was added. As shown in FIGS. 6B and 6C, the most distributed interconnection width was extended from about 7 μm to about 22 μm as the glycerol concentration increased from 10 vol % to 40 vol %.

It was noteworthy that as shown in FIG. 6D, despite a change in the interconnection width, the average size of the pores was constantly maintained at a level of about 50 μm even when the glycerol content changed to 10 to 30 vol %. This means that in the range of 10 to 30 vol % of the glycerol concentration at a 50 vol % sugar particle composition, only the interconnection width may be independently adjusted without changes in pore size, and presents very significant adjustability in terms of a structural design.

### [Experimental Example 5] Analysis of Changes in Porous Structure Characteristics According to Sugar Particle Size

A microstructure of a porous structure made by p-ITPI (Example 4) using sugar particles having various sizes was analyzed. SEM image analysis and quantitative measurement of the fabricated porous structure were performed by dividing the particle size into about 30 μm, 100 to 300 μm, 300 to 500 μm, and 500 μm or more.

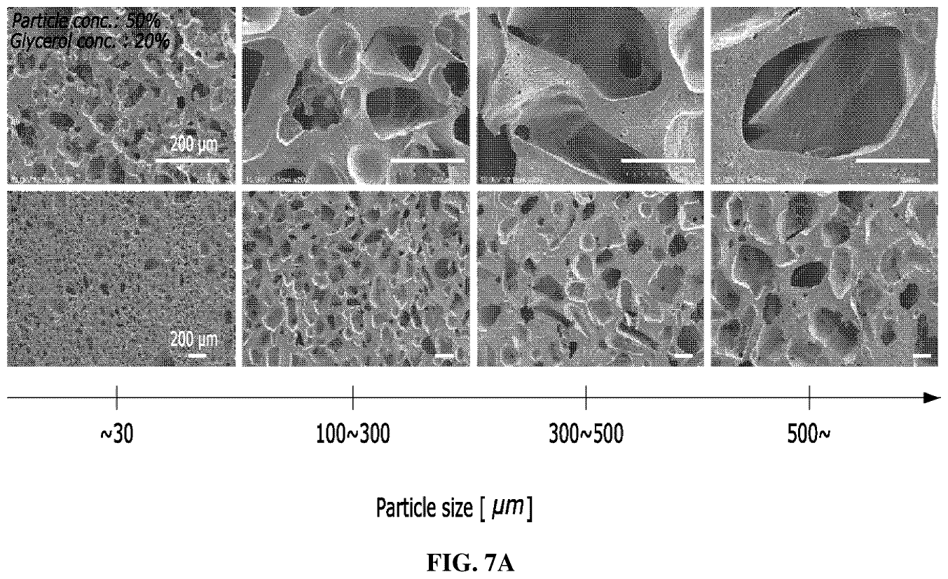

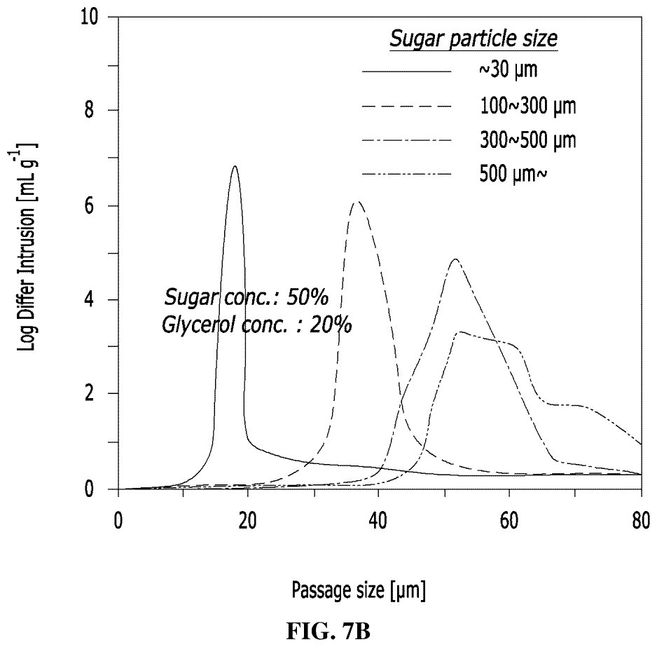

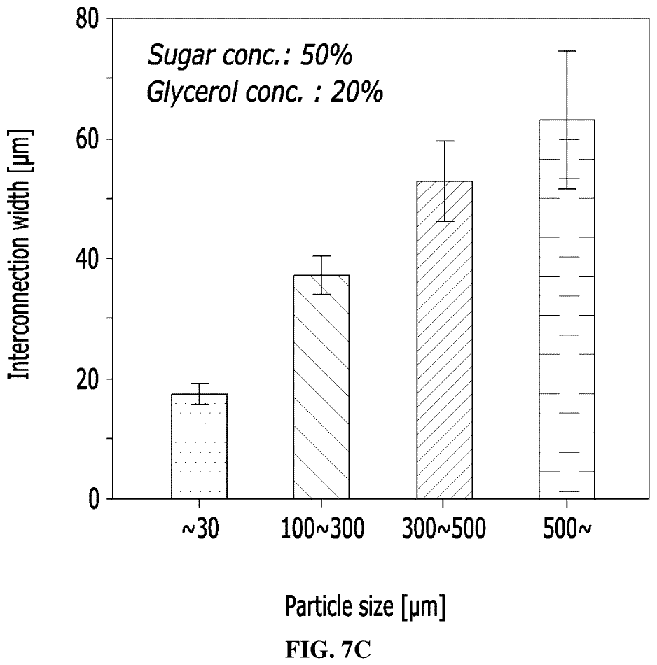

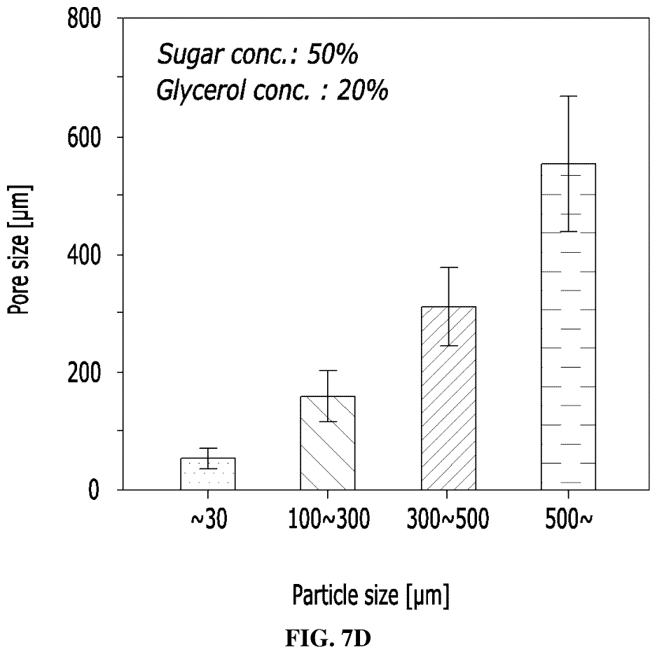

As can be observed from the SEM image shown in FIG. 7A, there was a distinct difference in the microstructure of the formed porous structure depending on a sugar particle size. As shown in FIG. 7C, as the size of the sugar particles increased, the most distributed width of the interconnections also tended to increase, which extended from about 20 μm to about 60 μm.

In addition, as shown in FIG. 7D, the pore size also changed in a form directly proportional to the sugar particle size, and the average pore size was about 30 μm when particles having a size of about 30 μm were used, and the pore size was enlarged to about 550 μm when particles with a size of 500 μm or more were used. These results show that the sugar particles serve as a direct structural reference point not only for pore formation as a sacrificial template, but also for connection formation.

### [Experimental Example 6] Evaluation of ITPI Applicability to Various Continuous Medium Materials

Microstructures of porous structures made by p-ITPI (Example 5) using various continuous medium materials were observed, compared, and analyzed. The applicability of ITPI using PDMS, Ecoflex 00-30 and Polyurethane as continuous media was evaluated.

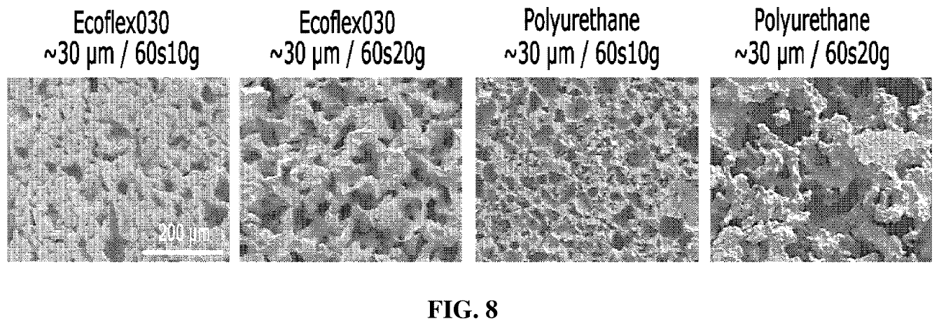

As shown in FIG. 8, in both the materials (Ecoflex 00-30 and Polyurethane), it was found that the microstructure of the formed porous structure was developed distinctly as the glycerol concentration was increased. This means that a formation mechanism of interparticle connections through capillary bridges may similarly be applied even to continuous media other than PDMS. These results suggest that the ITPI system is applicable to various prepolymer-based materials and can be extended to a variety of applications by ensuring flexibility in material selection.

### [Experimental Example 7] Evaluation of Mechanical Properties of Porous PDMS Structure

To evaluate the mechanical elastic properties of a porous PDMS structure made by p-ITPI, a compression test was performed on specimens molded into square shapes. Stress-strain curves, repeated compression durability, response characteristics according to a compression rate, and the like of specimens prepared at various glycerol concentrations (0, 5, 10, 15, and 20 vol %) were analyzed.

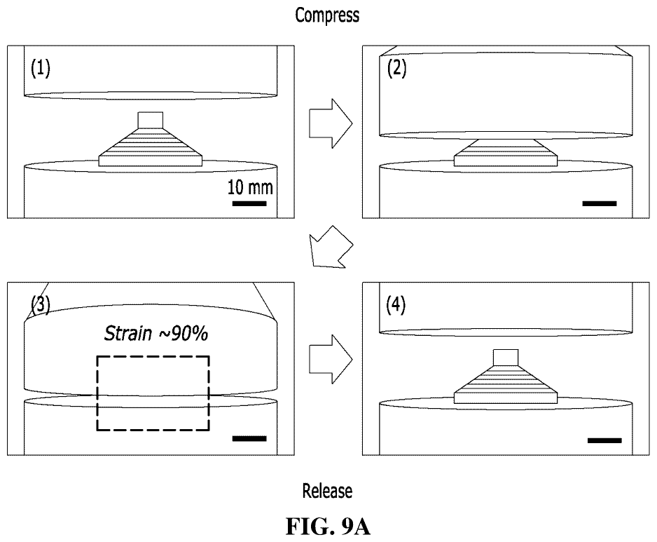

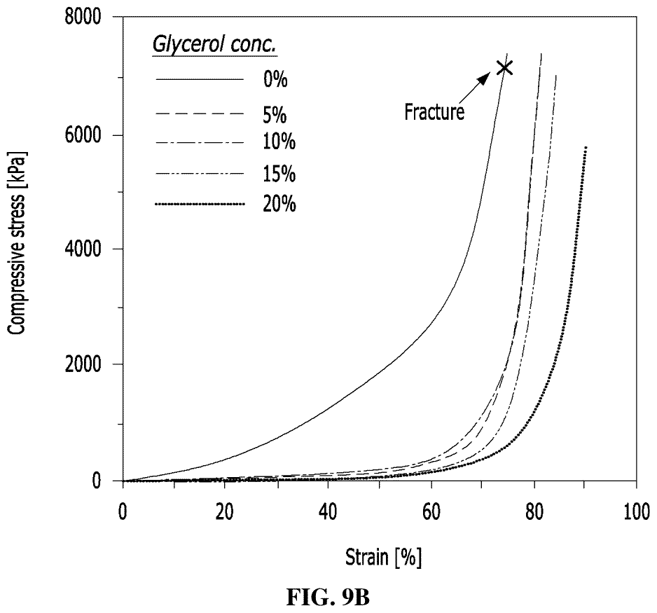

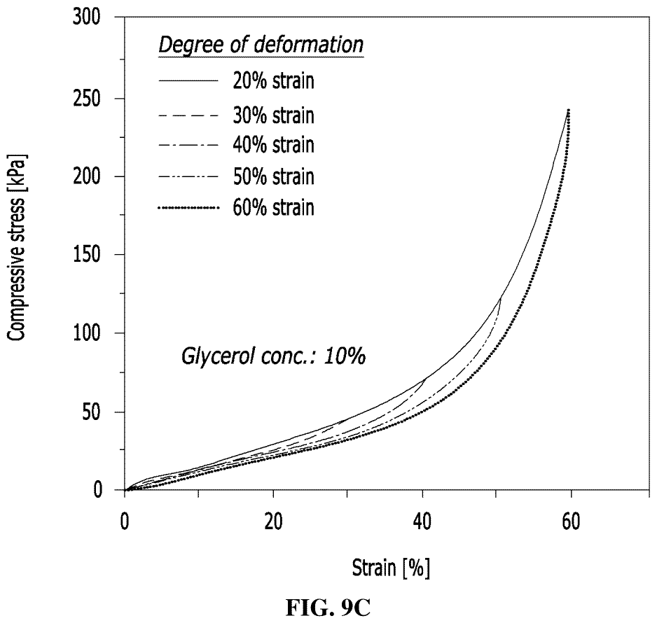

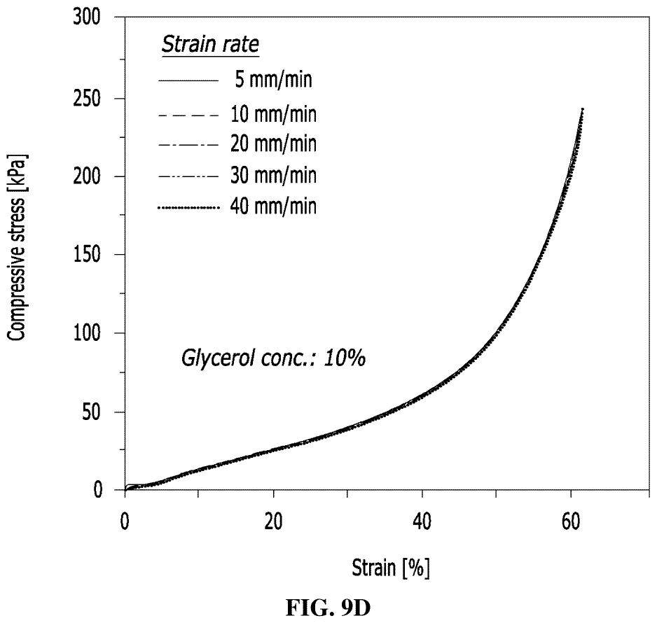

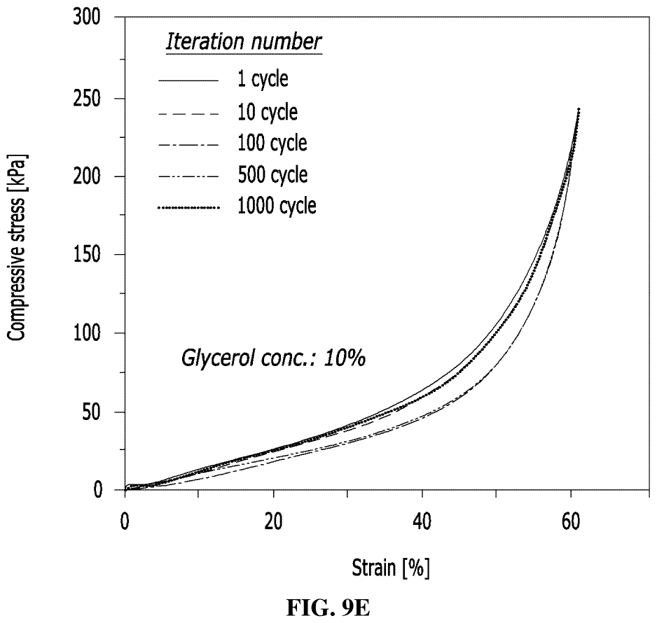

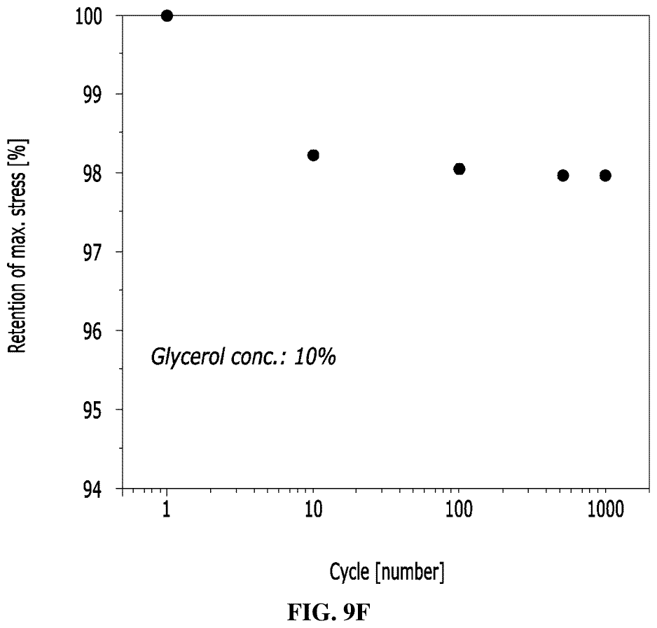

As shown in FIG. 9A, a structure fabricated by a 3D printing method showed very good elasticity due to a porous structure formed therein, and was compressible without structural damage even under a high strain rate of up to 90%, and quickly restored to its original shape after load removal.

As shown in FIG. 9B, as a result of measuring a stress-strain (σ-ε) curve under a fixed compression rate (20 mm/min) for quantitative elasticity analysis, the highest compressive strength was shown in specimens fabricated with ink of a composition without containing glycerol, and breakage occurred at a strain of about 70%. On the other hand, specimens prepared with p-ITPI containing 5 to 10% glycerol showed a similar mechanical response and gradually lower compressive strength under the same strain conditions as the concentration increased to 15 to 20%. In particular, the 10% glycerol composition was measured to withstand a stress of up to about 5.4 MPa at about 80% strain, which was a value equivalent to about 54,000 times the weight of the structure itself, indicating a super-rigid property capable of effectively supporting external loads.

The stress-strain curve (FIG. 9C) of the glycerol 10% composition structure showed the mechanical behavior of a typical open-cell foam. The corresponding curve was divided into three main regions, which consisted of (1) a linear elastic region (modulus of about 150 kPa) formed by bending of the cell wall at a strain rate of less than about 25%, (2) a plateau region exhibited by buckling of the cell structure in a range of about 25 to 50%, and (3) a region in which stress increased rapidly due to rapid condensation of the cell at a strain rate of about 50% or more. In particular, the elastic region and the plateau region were connected quasilinearly to reflect the soft stress transfer characteristics of the structure.

As shown in FIGS. 9D and 9F, the repeatability and durability of the compression test were also confirmed. As a result of hysteresis loops performed at 1000 repetitions of compression and various compression rate conditions for the same specimen, the loss of maximum stress even after 1000 cycles was only about 2%. This represents a stress retention of about 98% and demonstrates that the structure has excellent energy dissipation performance and fast recovery capability (recovery speed of at least 40 mm/min) together with superelastic properties.

### [Experimental Example 8] Evaluation of Oil-Water Separation Performance of Porous Structure

The oil-water separation performance of the porous PDMS structure was quantitatively evaluated. Porosity, oil absorption capacity and selective absorption properties of porous sponges fabricated at various glycerol concentrations (0, 5, 10, 15, and 20 vol %) were analyzed.

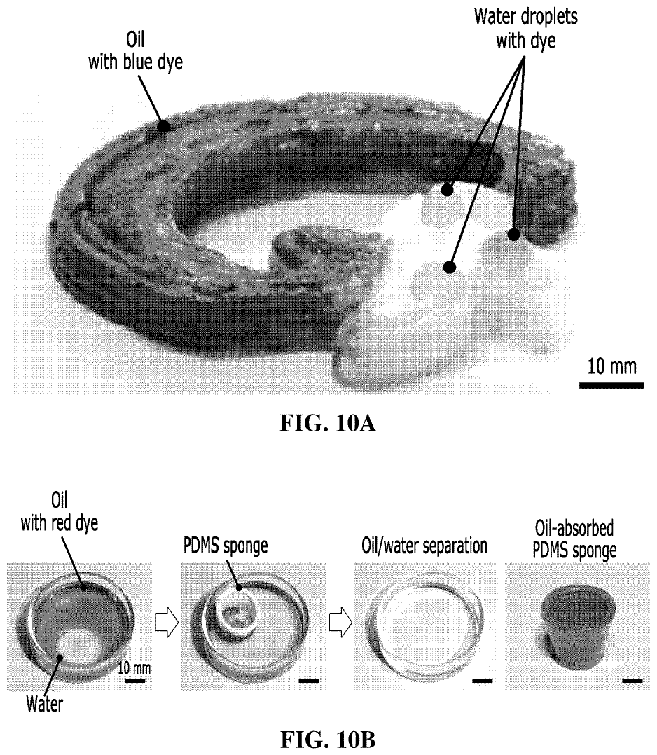

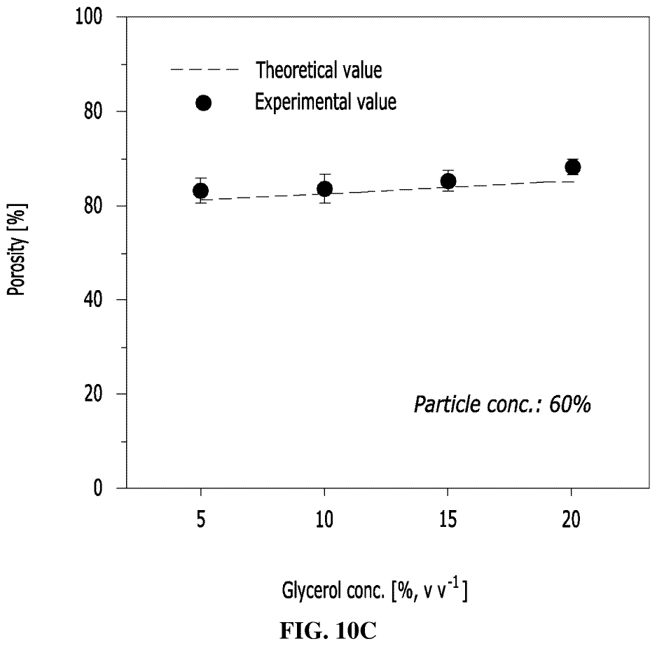

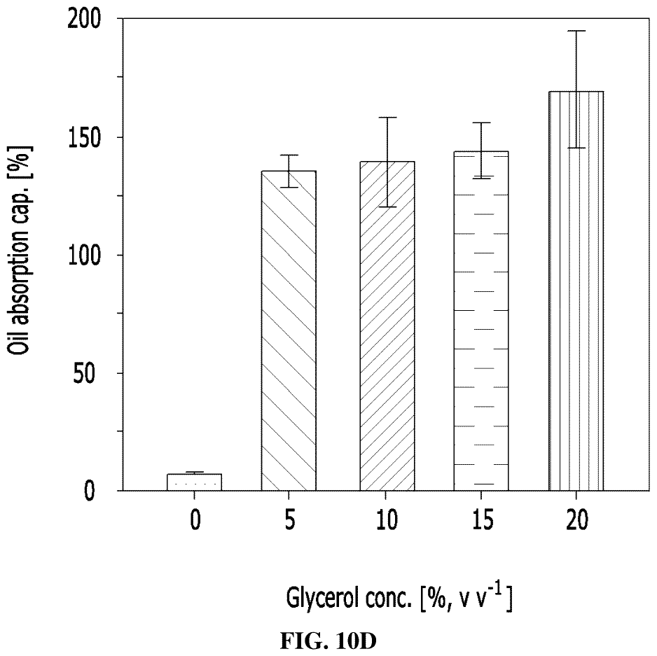

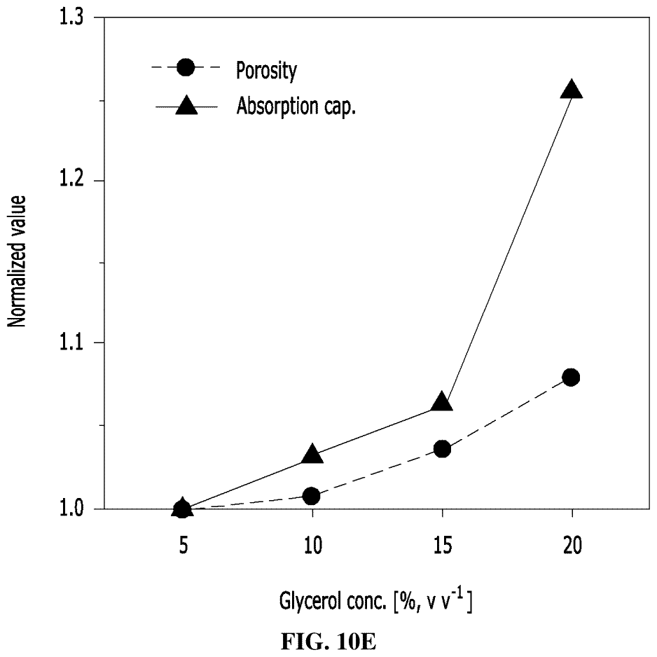

As shown in FIG. 10A, PDMS was a polymer material having inherent hydrophobic and oleophilic properties, and had a property of selectively absorbing only oil in a water/oil mixed environment when there was a pore structure capable of absorbing oil therein.

In the experiment shown in FIG. 10B, the fabricated porous PDMS sponge was free to move while floating on water and quickly absorbed the oil whenever coming into contact with an oil membrane. In this process, a locally white area was formed on the surface of water from which the oil was removed, which served as visual evidence that the oil was removed and the filtered water remained in the corresponding position.

As shown in FIGS. 10C and 10D, Comparative Example 1 (structure without containing glycerol) had almost no internal connection structure, and the diesel absorption amount was only about 10%, and the absorption amount was significantly increased in the composition in which 5% or more of glycerol was added. In particular, oil absorption capacities of about 135% in a glycerol 5% composition and up to 170% in a glycerol 20% composition were recorded.

As a result of analyzing a correlation between porosity and oil absorption capacity shown in FIG. 10E, as the glycerol concentration increased from 5% to 20%, normalized porosity increased slightly from 1.0 to 1.08, while a normalized oil absorption capacity increased sharply from 1.0 to 1.25. It is interpreted that such a difference is because the interconnection width extends as the glycerol concentration increases, so that the mechanical rigidity of the structure is reduced and thus the structure swells more easily upon oil absorption.

In addition, the porous PDMS sponge was reusable without structural damage by repeatedly absorbing diesel and organic solvents and discharging the diesel and organic solvents by pressing by hand, which shows that the sponge developed in this study may be used as eco-friendly and economical materials for repeated use in an oil purification and recovery system.

### [Experimental Example 9] Evaluation of Liquid Release Control in Microfluidic System of Porous Structure

The ability to control liquid release in a microfluidic system based on a porous PDMS sponge capable of controlling an interconnected structure was evaluated. The liquid release rate control properties of porous sponges fabricated at various glycerol concentrations (5, 10, 15, and 20 vol %) were analyzed.

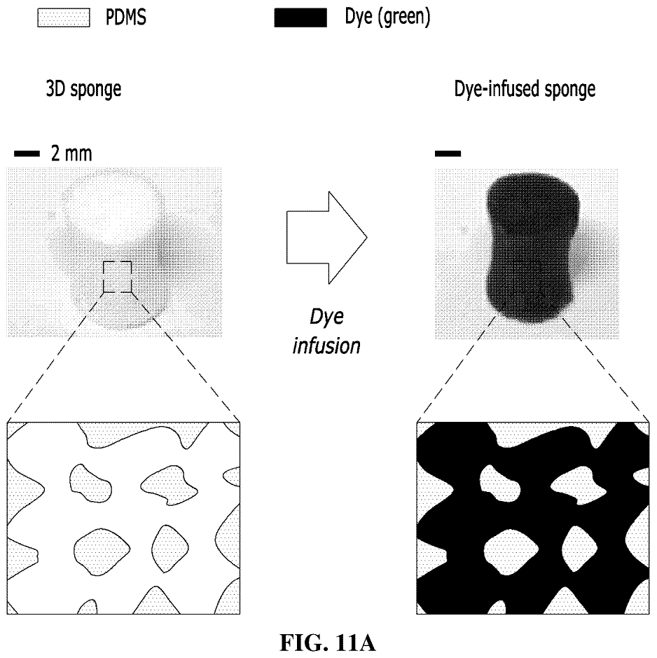

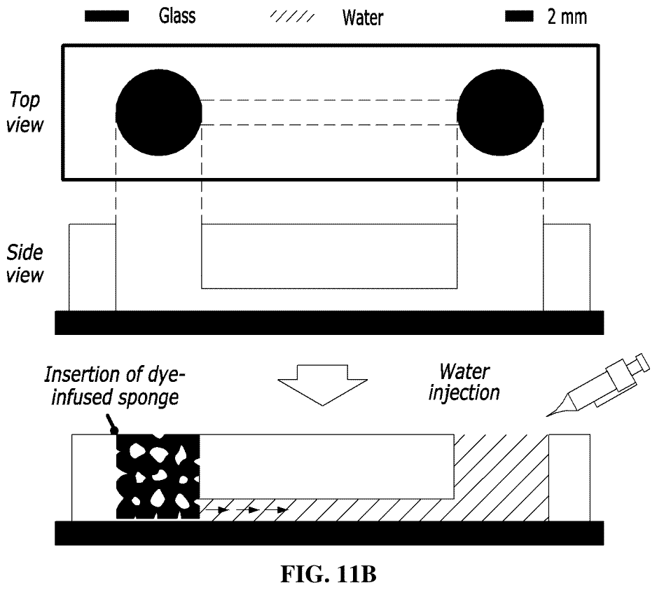

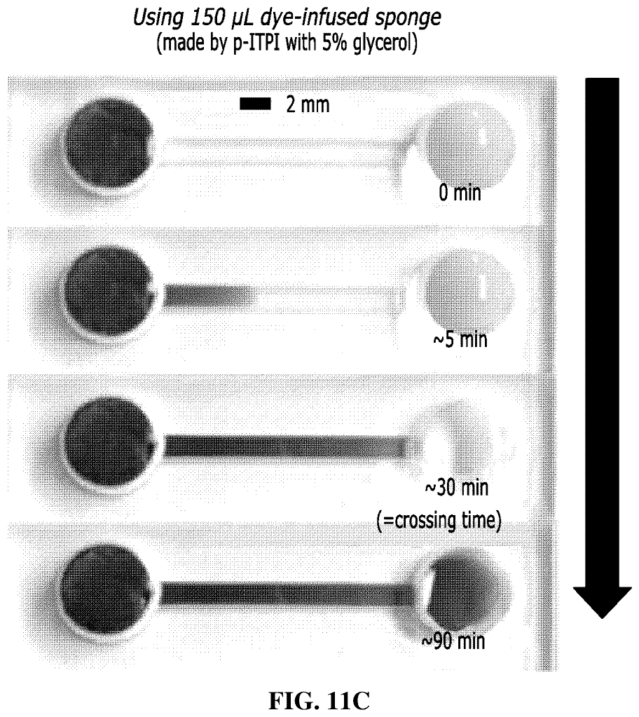

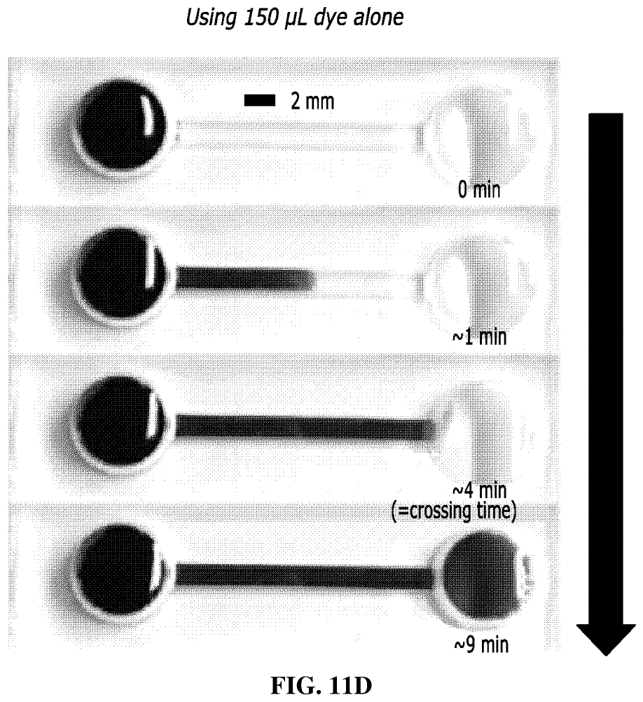

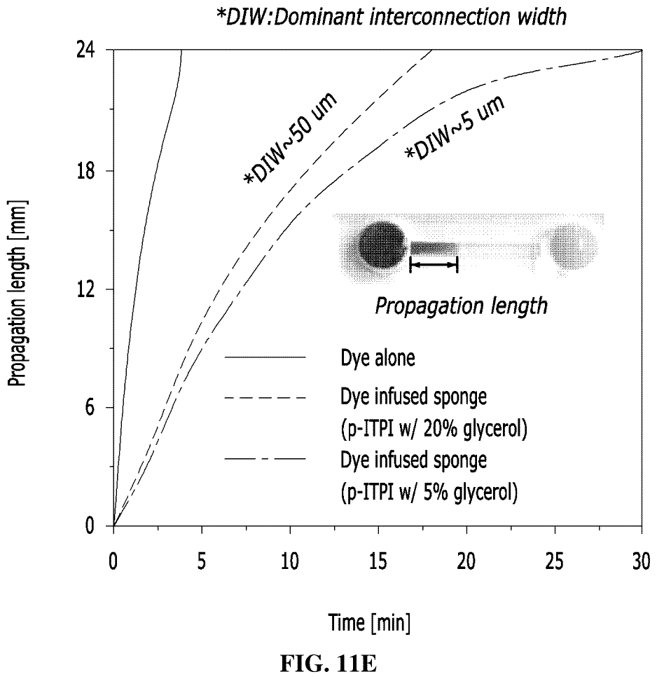

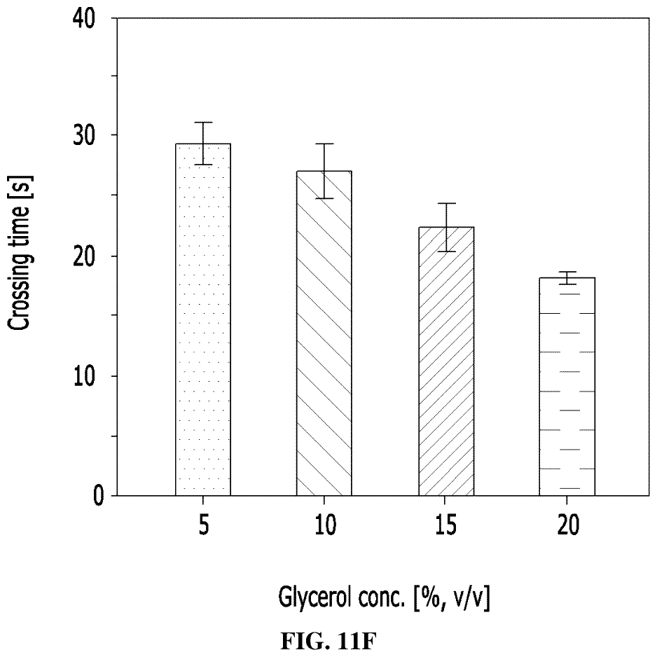

As shown in FIG. 11A, a porous PDMS sponge having a diameter of 6 mm and a height of 8 mm was infused with about 150 μL of a green edible aqueous dye by a mechanical imbibition (forced imbibition) method. In the microfluidic channel system shown in FIG. 11B, the dye-infused sponge was disposed to observe the release and diffusion behavior of the dye.

As shown in FIG. 11C, the dye reached an opposite well only at about 30 minutes when using a sponge of a glycerol 5% composition. In contrast, as shown in FIG. 11D, when the same amount of dye was directly infused with a pipette, the dye reached the opposite well only at about 4 minutes, and the delivery rate through the sponge was found to be about 7.5 times slower. This is a result of demonstrating that the sponge may serve as a manual pump to gradually release the liquid.

Through a dye diffusion curve analysis shown in FIG. 11E, it was confirmed that the interconnection width increased as the glycerol concentration increased, and thus the dye diffusion rate tended to increase. As shown in FIG. 11F, the crossing time was shortened from about 30 minutes to 19 minutes when the glycerol concentration increased from 5% to 20%, which was interpreted because the expansion of the interconnection structure induced smooth fluid movement.

As such, the fact that the fluid release rate may be structurally adjusted according to a composition of p-ITPI means a design strategy that is substantially applicable to various fluid control systems.

### [Experimental Example 10] Evaluation of Electrical Properties of Liquid Metal-Filled Porous PDMS Electrodes (Continued)

The electrical properties of a porous PDMS electrode (Example 6) filled with a liquid metal (LM) were evaluated under various external stimulation conditions. A resistance change rate according to stimuli such as tensile, bending, and pressure was measured, and the applicability in an actual coil embolization simulation environment was verified.

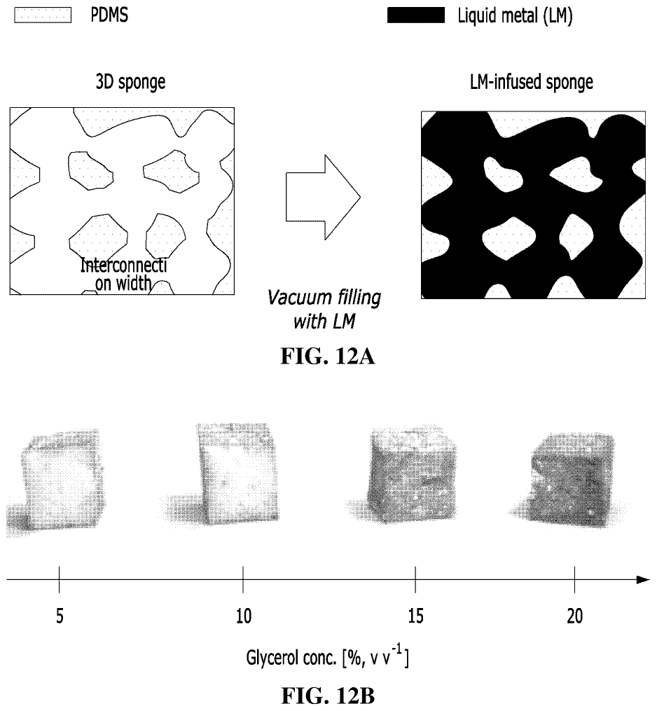

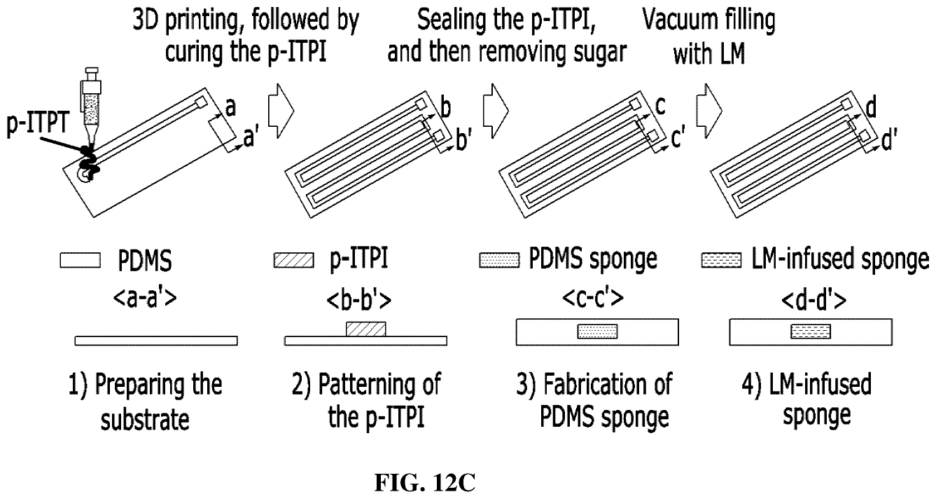

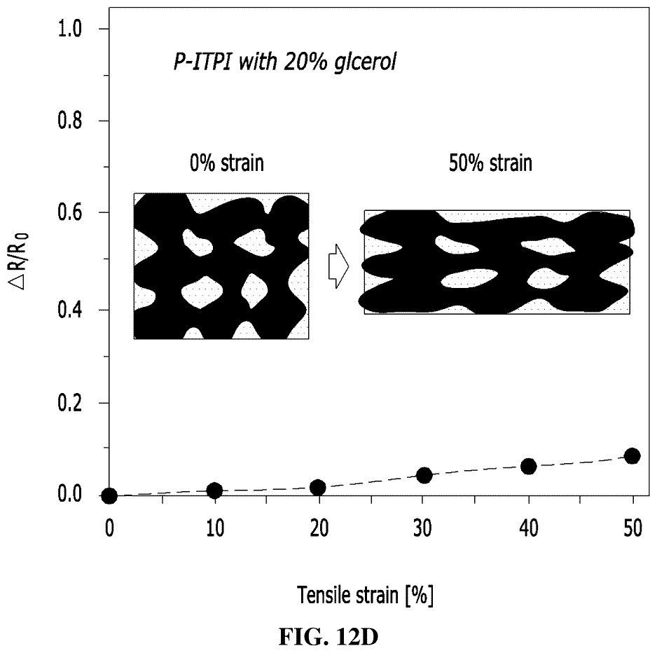

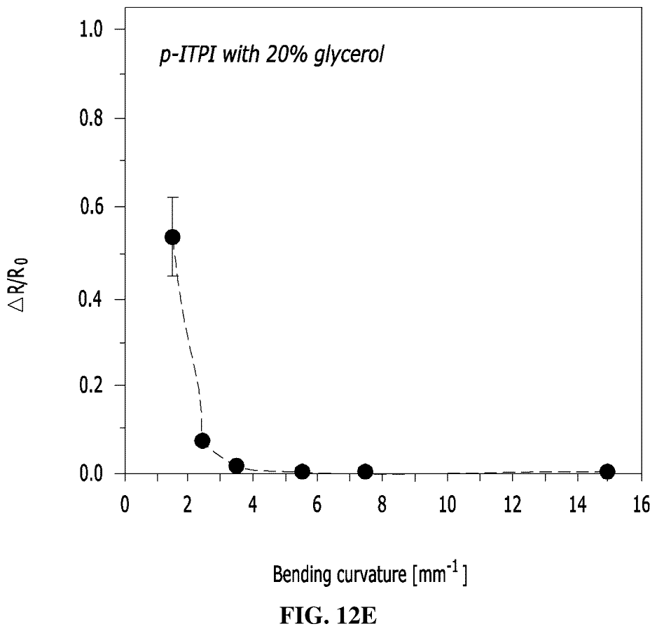

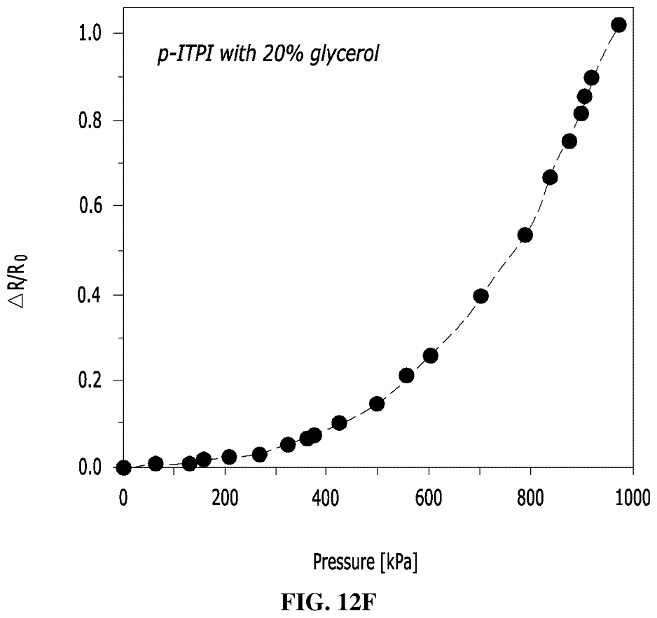

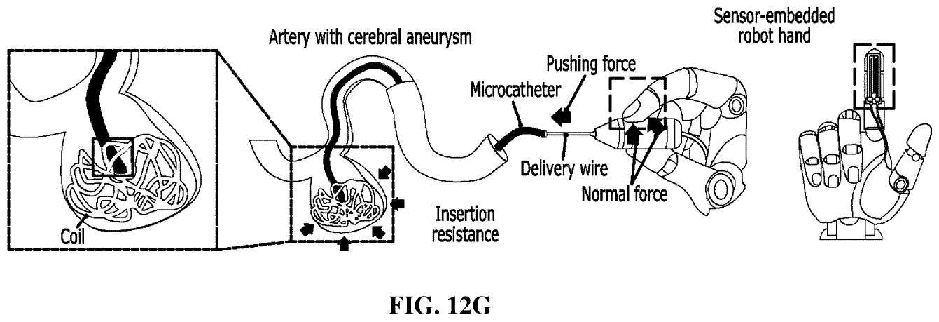

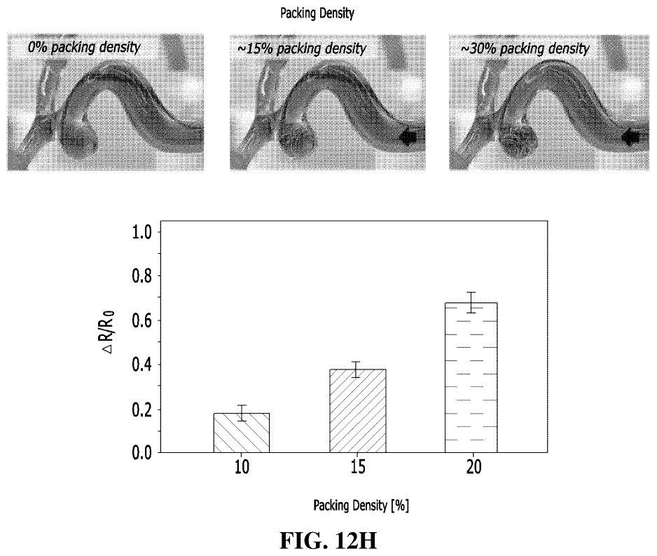

As shown in FIG. 12B, as a result of being calculated based on the effective surface tensile (γ≈534 mN/m) of Galinstan, filling was possible when an interconnection width W was at least 20 μm, and as a result of the experiment, it was confirmed that stable LM filling was achieved in a p-ITPI-based sponge having a glycerol concentration of 15% or more.

The electrical sensitivity of the fabricated LM-infused electrode was analyzed through a resistance change rate (ΔR/R₀) under various external stimulation conditions, such as tensile, bending, and pressure. As shown in FIG. 12D, in a tensile experiment, a resistance change rate of about 10% or less was maintained up to a maximum strain of 50%, which means that stable conductive properties are maintained even at deformation of a general human body motion level.

As a result of the bending experiment shown in FIG. 12E, the resistance change rate was maintained at 10% or less until a curvature was about 0.40 mm⁻¹, and sharply increased to about 50% at 0.65 mm⁻¹. This suggests that local structural collapse occurs at a high curvature.

As shown in FIG. 12F, pressure stimulation induced a more sensitive response, and a resistance change rate of about 100% was shown at a pressure of 1000 kPa. This is interpreted as a result of the shrinkage of pores in the structure and the large deformation of an internal conduction path, and shows the availability as a pressure sensor.

In order to evaluate the applicability in a coil embolization simulation environment, as shown in FIG. 12G, an experiment was performed in which an LM-infused electrode sensor was attached to a hand to sense a vertical stress generated during a coil pusher operation process. The coil embolization was a procedure in which a platinum coil was inserted into the cerebral aneurysm to block blood flow, a microcatheter was inserted through the femoral artery and moved to a lesion position, and then the coil was inserted using a coil delivery wire and a coil pusher operating the coil delivery wire.

As shown in FIG. 12H, a resistance change of about 20% was observed simply by an operation of gripping the coil pusher, and resistance changes of about 40% and 70% were measured when a coil fill rate reached 25% and 30%, respectively. In this process, as the coil was gradually filled, the internal resistance of the aneurysm increased, and when a packing density of about 30% was reached, it was considered a high-density filled state, and thereafter, when excessive pressure was applied, the risk of aneurysmal rupture rapidly increased. Therefore, a minute change in resistance transmitted to the fingertip during the coil pusher operation was an important criterion for determining the safety of the procedure.

Through the experimental results, it was demonstrated that a LM-infused PDMS electrode sensor detected an increase in aneurysm internal pressure in real time and may provide a quantitative criterion to stop coil insertion at a safe point in time. Such a property is based on the interaction between the LM and the porous sponge, and as a result, it is meant that the corresponding electrode may function as a highly-reliable flexible and stretchable piezoresistive sensor.

The aforementioned description of the present disclosure is to be exemplified, and it will be understood by those skilled in the art that the present disclosure may be easily modified in other detailed forms without changing the technical spirit or required features of the present disclosure. Therefore, it should be appreciated that the examples described above are illustrative in all aspects and are not restricted. For example, each component described as a singular form may be implemented in a distributed manner, and components described as being distributed may also be implemented in a combined form.

The scope of the present disclosure is represented by appended claims to be described below rather than the detailed description, and it is to be interpreted that the meaning and scope of the claims and all the changes or modified forms derived from the equivalents thereof come within the scope of the present disclosure.

What is claimed is:

1. An interconnection-tunable porous ink comprising:
a continuous medium containing a polymer or polymer precursor;
solid particles dispersed in the continuous medium; and
a surface wetting liquid flowing on the solid particle surface,
wherein the surface wetting liquid forms capillary bridges between the solid particles to exhibit viscoelastic properties.

2. The interconnection-tunable porous ink of claim 1, wherein the surface wetting liquid has a contact angle of less than 90° on the solid particle surface.

3. The interconnection-tunable porous ink of claim 1, wherein the surface wetting liquid is immiscible with the continuous medium.

4. The interconnection-tunable porous ink of claim 1, wherein the solid particles are not dissolved in the continuous medium and the surface wetting liquid.

5. The interconnection-tunable porous ink of claim 1, wherein the solid particles are dissolved through a solvent or sublimed by heat.

6. The interconnection-tunable porous ink of claim 1, wherein the surface wetting liquid is removed through a solvent or vaporized by heat.

7. The interconnection-tunable porous ink of claim 1, wherein a yield stress of the interconnection-tunable porous ink is increased by the capillary bridges.

8. The interconnection-tunable porous ink of claim 1, wherein the polymer or polymer precursor is selected from the group consisting of polydimethylsiloxane (PDMS), silicone-based room temperature vulcanizing resins (RTV), Ecoflex, polyurethane, epoxy resin, acrylate-based resin, polyvinyl alcohol (PVA), polyethylene glycol (PEG), Pluronic F127, alginate, gelatin, collagen, agarose, hyaluronic acid, chitosan, carrageenan, polyacrylamide, polyethylene glycol diacrylate (PEGDA), 2-hydroxyethyl methacrylate (HEMA), N-isopropylacrylamide (NIPAM), polycaprolactone (PCL), polyacrylic acid (PAA), and combinations thereof.

9. The interconnection-tunable porous ink of claim 1, wherein the solid particles are selected from the group consisting of sugar (sucrose) particles, sodium chloride (NaCl) particles, potassium chloride (KCl) particles, polystyrene, polymethylmethacrylate (PMMA), polyvinylalcohol (PVA), camphor, urea, citric acid, naphthalene cellulose nanocrystals, cellulose nanofibers, starch particles, chitin/chitosan microparticles, calcium carbonate, hydroxyapatite, silk fibroin microparticles, polylactic acid (PLA) particles, polycaprolactone microparticles, and combinations thereof.

10. The interconnection-tunable porous ink of claim 1, wherein the surface wetting liquid is selected from the group consisting of glycerol, ethylene glycol, propylene glycol, water, a surfactant, dimethyl carbonate (DMC), isopropyl alcohol (IPA), ethanol, acetone, dimethyl sulfoxide (DMSO), toluene, silicone oil, mineral oil, chloroform, hexane, heptane, fluorinated oils, and combinations thereof.

11. The interconnection-tunable porous ink of claim 1, wherein the solid particles are included in 30 vol % to 90 vol % with respect to the total composition of the interconnection-tunable porous ink.

12. The interconnection-tunable porous ink of claim 1, wherein a volume ratio (R) of the surface wetting liquid to the volume of the solid particles represented by the following Equation 1 is 0.1 vol % to 70 vol %,
wherein Equation 1 is
$$R ( vol \% ) = \frac{Volume of surface wetting liquid}{\begin{matrix}Volume of solid particles + \\ Volume of surface wetting liquid\end{matrix}} \times 100.$$

13. The interconnection-tunable porous ink of claim 1, wherein the solid particles have a diameter of 0.1 μm to 1000 μm.

14. The interconnection-tunable porous ink of claim 1, wherein the interconnection-tunable porous ink has a yield stress of 200 Pa or more.

15. The interconnection-tunable porous ink of claim 14, wherein the interconnection-tunable porous ink exhibits a liquid-like behavior under a shear stress higher than the yield stress of the interconnection-tunable porous ink, and
exhibits a solid-like behavior under a shear stress lower than the yield stress of the interconnection-tunable porous ink.

16. A 3D printing method using the interconnection-tunable porous ink according to claim 1, comprising:
ejecting the interconnection-tunable porous ink through a 3D printer to form a structure having a predetermined shape;
curing the structure; and
removing the solid particles and the surface wetting liquid,
wherein pores are formed in the structure by removing the solid particles, and
interconnections are formed in the structure by removing capillary bridges formed of the surface wetting liquid.

17. The 3D printing method of claim 16, wherein the curing is performed by a thermal curing, photocuring or auto-curing process.

18. The 3D printing method of claim 16, wherein a diameter of the interconnection is controlled by adjusting the concentration of the surface wetting liquid included in the interconnection-tunable porous ink.

19. The 3D printing method of claim 16, wherein the size of the pores is controlled by adjusting the size of the solid particles included in the interconnection-tunable porous ink.

20. A porous structure fabricated by the 3D printing method according to claim 16.
